(19) United States
(12) Patent Application Publication
(10) Pub. No.: US 2023/0321607 A1
(43) Pub. Date: Oct. 12, 2023

(54) Monolithic Membrane Filters

(71) Applicant: InnoSpire Technologies GmbH, Idstein (DE)

(72) Inventors: Ulrich MEYER-BLUMENROTH, Idstein (DE); Gisela JUNG, Wiesbaden (DE)

(21) Appl. No.: 18/041,935

(22) PCT Filed: Aug. 16, 2021
(86) PCT No.: PCT/EP2021/072740

§ 371 Date: Feb. 16, 2023

(30) Foreign Application Priority Data
Aug. 17, 2020 (DE) 10 2020 121 546.0
Aug. 17, 2020 (DE) 10 2020 121 547.9
Aug. 17, 2020 (DE) 10 2020 121 548.7
Aug. 17, 2020 (DE) 10 2020 121 549.5

(51) Int. Cl. B01D 67/00; B01D 63/06; B01D 46/24

(52) U.S. Cl. CPC B01D 67/00415; B01D 63/066; B01D 46/247; B01D 46/24491; B01D 46/2484; B33Y 10/00

(57) ABSTRACT

An additive manufacturing method for producing a component having at least partially or at least locally a porous material structure includes providing a porous or porosable base material, applying the porous or porosable base material to build up the component, and adjusting a porosity of the porous or porosable base material during the applying.

### BACKGROUND AND SUMMARY OF THE INVENTION

The present invention relates to a method for manufacturing monolithic components and to monolithic components, in particular as membrane filters.

Membrane filters for filtering or separating substances from mostly liquid mixtures are known as such. Such a mixture can be a disperse medium or, for example, a solution in which further components are dissolved in a basic substance.

Membrane filters are used in various applications, e.g., in the treatment of water and food, in the manufacture of pharmaceutical products, in biotechnological or chemical processes. An example of such an application can be the separation of alcohol from beer for the production of alcohol-free beer. A particularly gentle process preferably allows alcohol removal with minimal flavor degradation. Another application can be the separation of cells and cell fragments from active ingredient solutions in the biotechnological production of pharmaceuticals. Here, intensive research is still being carried out into further developments in order, for example, to increase the throughput of medium to be filtered or to further reduce costs. In contrast to medical equipment, technical systems may require much larger membrane areas.

Since each different area of application has different requirements, particularly with regard to the material, design, or size of the filters, and process requirements such as temperature, pressure, volume, and aggressiveness of the media in contact, or else special hygiene requirements have to be taken into account, the membrane filter market is still under development. A universal approach that is at least capable of covering a majority of different application areas has not yet been achieved.

Furthermore, it is not uncommon for filtration systems to fail due to the limited mechanical and/or chemical stability of known modules. For example, modules made of polymer materials such as PP typically cannot withstand higher loads such as temperatures above 60° C. or higher transmembrane pressures (above 3 bar), or at least not over longer periods of time without damage. For many applications, however, this would be desirable.

Steam sterilization, e.g., at 121° C., which is particularly necessary in hygienically demanding areas, can only be repeated in a small number of cycles, if at all. Similarly, cleaning at elevated temperatures, high and/or low pH values or with oxidizing cleaning agents limits the service life of the modules. Ceramic filters, on the other hand, are sensitive to temperature shocks or mechanical action.

Due to the partly automated manufacturing processes, membrane filters are nowadays produced as standardized products with a predefined geometry, whereby adaptations of the membrane filters to special requirements from the process control, such as for high viscosities and/or low pressure losses during flow or for difficult installation environments, are practically excluded or not provided for, as the resulting lower quantities would drive the unit costs into unsaleable regions.

It is one of the fundaments of the present invention that the described limitations of currently existing filters and those described in the literature result essentially from their construction, because they are assembled from prefabricated components.

In the context of the present invention, it has been recognized in retrospect on these known filters that it is a problem when filter modules typically consist of various components, in particular of different types, which are manufactured by different processes and subsequently reversibly or irreversibly connected to each other. Separate components include membranes as flatware or tubes, components for fluid supply and removal (e.g., pressure tubes, connectors, permeate tubes, aeration tubes, . . . ) and components for fluid distribution and mixing (e.g., spacers, ATDs, . . . ). So far, filter modules have been used, which in particular are provided with sealing rings or other sealing means and are installed in a separate housing with separate connections. The sealing to avoid cross flows between the shell side and the lumen side is complex and limits the possible application fields for membrane filters to a decisive extent.

An example of known welded tubular membranes is described in the European Disclosure Publication EP 88 108 462 A. Typically, various joining processes, such as in particular welding or the filling of potting compound, are necessary in order to achieve a seal and/or targeted fluid flow in the filter module. In the case of such a “modular design”, it is interesting in principle that different materials can be used to fit precisely and thus possibly more cost-effectively, and can thus be selected specifically according to the requirements.

However, in the making of the present invention it has been recognized that it may be disadvantageous that the different components behave differently with respect to each other, for example, under stress, such as temperature changes, pressure changes, or even swelling of the material, and thus deteriorate or fail the performance of the filter.

Typically, the membranes are bonded or welded to the other components to form a filter element. Mechanical seals, which are clamped between membranes and housing, are also common, e.g., with ceramic membranes. Connectors (filter element to piping system) are often detachably connected to the filter unit, e.g., inlet and outlet caps via clamps, flanges or threads. Seals prevent a “short circuit” between feed and filtrate.

In the case of capillary modules, for example, capillary fractures at the embedding, detachment of adhesive (potting) from the housing wall or potting failures occur time and again. In the case of flat membranes bonded over their entire surface, e.g., in submerged modules, delamination is observed between the laminate layers. In the case of ceramic tubular membranes or multi-channel elements, the elastomer seal used is often the limiting weak point of the entire filter unit. Both the ceramic of the built-up membrane and the stainless steel typically used for the housing can have a considerably higher temperature and/or chemical resistance than the sealing material used.

Another disadvantage of known multi-part filter modules is that the joining processes used repeatedly prove to be error-prone. It is typical that various joining processes, such as welding in particular or the filling of potting compound, are necessary to achieve sealing and/or liquid guidance in a filter module.

For example, in the welding of tubular membranes (European Disclosure Publication EP 88 108 462 A), although no foreign materials or different substances are used, the surfaces coming into contact before welding are often inadequately prepared for welding, so that a tight and reliable joint cannot be made. The surfaces of the welding tools used must also be absolutely clean during each welding operation. Adhering polymer melt from a previous welding process, for example, can adversely affect the result of the weld. Even in the case of fully automatic welding of an entire pipe module, leaky welds detected in quality control integrity tests are the most frequent cause of defects and then require reworking or lead to rejects. Particularly critical are those welds that do not show up as leaks in the integrity test, but are nevertheless not completely welded. Such joints have an increased risk of failure and lead to leaks after a short period of operation with the consequence of a failure or a customer complaint.

Capillary diaphragms are mostly bonded into housings. During the curing of the potting compound, the crosslinking reaction can cause shrinkage of the material. The transition from the potting block to the housing of such a filter is therefore typically under stress, which can lead to at least partial detachment of the potting compound from the housing wall in practical use under changing temperatures and/or pressures. Reliable separation between the flow on the lumen side and the flow on the shell side is thus no longer guaranteed.

Further disadvantages of known filters arise from the limited design possibilities. When casting capillary or tubular membranes, the transitions in or between the components, such as between the membrane and an adjoining end plate, cannot be freely selected. Rather, they are determined by the flow and wetting behavior of the potting compound used. Advantageous designs that would improve the mechanical stability and/or could improve the flow guidance of the fluid cannot be specifically produced. Thus, mechanical fractures occur at this transition point and unfavorable flows occur, leading to pressure peaks and wear. Typically, furthermore, on the inflow side, the diaphragms with the potting compound are cut flush with the end of the housing. The cut edges of the diaphragms are sharp, and depending on the diaphragm and application, these cut edges may need to be sealed. This significantly impairs the flow of the incoming fluid.

In ceramic membrane filters, the currently common design leads to their lack of robustness against mechanical influences, such as in particular shock impacts when dropped or improperly handled. For example, the diaphragms are usually anchored only at their ends in the housing and/or in a potting compound. The brittleness of the material therefore regularly leads to diaphragm fractures between the end plates, which can occur as a result of the action of mechanical loads, such as a shock load or a shear load. A very similar situation also arises with rapid temperature changes. For example, if a hot fluid suddenly flows through the diaphragms, they expand. The still cold housing may not allow this expansion and considerable stresses may build up in the diaphragms, which also regularly lead to diaphragm rupture.

In view of the general background of the invention described above and the identification process also described therein in the context of the invention disclosure of the present application and the disadvantages identified therein, the present invention has therefore set itself the task of solving precisely those aforementioned problems or at least introducing improvements thereto. Specifically, it is an object of the invention to provide filter modules or membrane filters or components which are considerably more robust with respect to their handling, and alternatively or cumulatively also with respect to the applicable process and operating parameters. The invention solves the problem that the described aging processes of known filters are avoided or improved, and that failure rates of entire filter modules are reduced both in production and in operation.

The present invention thus also fulfills the further partial aspect of increasing the service life of filter modules or components in tough technical use and thus improving their economic efficiency.

The present invention further fulfills the partial aspect of providing filter modules or components that realize a further improved mixing of the fluids used and/or further increase the filtrate throughput. Thus, on the one hand, the yield can be increased and/or the throughput rate can be increased.

In addition to the aforementioned and numerous other aspects which the present invention solves, the present invention also provides a filter which can be adapted by simple means and which can be optimized in the manufacturing process for the specific subsequent application with respect to, for example, the parameters of filtration performance, conveying performance, with respect to the volumetric or mass flow rate of fluid and/or the mechanical load capacity or resistance to mechanical influences.

Alternatively or cumulatively, the invention has also set itself the task of simplifying the manufacturing process of filter modules and/or providing them more cost-effectively, or even individually adaptable to the specific requirement.

The improvements and new designs proposed in this description focus, among numerous other aspects, on providing a component suitable for separating constituents from a fluid. Such a separation is thus, for example, the filtration of a fluid, i.e., the separation of substances, for example, from a solution, the stripping or separation of suspended matter from a disperse medium such as a suspension. However, the invention is not limited to this.

In one underlying idea and in another aspect of the invention, the present invention focuses on providing monolithically constructed components for manufacturing filter modules. Such monolithic components, such as membrane filters, may be additively formed and/or have intrinsic porosity. For example, in a monolithic component, all components may be provided from a uniform base material or starting material.

Monolithic components are also typically manufactured as a whole and without interruption. Due to the absence of joined component-to-component transitions, they can be characterized by extreme robustness in application and can also be optimized for their intended use in terms of fluid dynamics as well as size and thus filtration capacity. There are various additive manufacturing processes already known, which offer great scope for design. Typically, the elements to be manufactured are built up in layers. However, the additive manufacturing processes known to date are inadequate in various respects, particularly for use in the construction of membrane modules, and are only ready for use with use of the present invention.

Additive manufacturing also allows, for example, for the production of geometries that are not possible with previously known processes for membrane or membrane module production. In particular, three-dimensional geometries should be emphasized which are prepared in such a way that a damping or force-absorbing shape can be provided. For example, there is often a force application in the longitudinal extension of the membrane modules, whereby even if the membrane modules are inserted stress-free into the respective holder or device, a change in length can occur during operation due to temperature change or chemical action and the membrane module or modules are stressed. The membrane module or modules are therefore preferably of stress-tolerant design, in particular longitudinal stress-tolerant. The stress-tolerant design of the membrane modules can be achieved by a three-dimensional geometry of the membrane tubes of the membrane module, i.e., a stress-tolerant shape of the membrane tubes. These geometries of the membrane tubes, of which a few particularly preferred embodiments are described in the remainder of this application, which could not be produced in this way or at least not economically in earlier manufacturing processes, have proved advantageous in test cycles within the scope of the present disclosure of the invention.

For example, the membrane module(s) can be provided stress-tolerant by using an inherent spring effect of the membrane module(s), so that a compression of the individual membrane tubes causes a deflection of the membrane tubes. The deflection of the membrane tube can be a twisting, or a bending or the like. Similarly, the stress tolerant design of the diaphragm tubes or diaphragm modules may also include a transverse stress tolerant provision. Membrane modules are occasionally subjected to transverse stresses, for example if they are not inserted accurately into the respective holder and the membrane module compensates for the inaccurate installation by twisting. This twisting can be transferred to the membrane tubes inside the membrane module.

The use of porous material systems for additive manufacturing described in the present invention also allows, for example, the reproducible generation of porous components with an average pore size of up to less than 1 μm, which has been an unsolved challenge to date. Thus, previous attempts in this regard required an immense amount of time for a single filter due to the high resolution required, which is unacceptably long for series production. From a technological point of view, the ratio between the achievable component size and the resolution of the component structure was also an obstacle to the extent that such filters could not be manufactured in technically relevant sizes. It is precisely this problem that is solved particularly elegantly by the approach shown in the present description.

In particular, the geometric resolution that can be provided by an application device, such as a 3D printer, is no longer an obstacle with regard to the achievable pore size. In a particularly advantageous design, the geometric resolution of the application device is then only relevant for the general shaping of the component or the membrane filter, but not for the specific pore size of the membrane filter.

The method according to the invention for producing a component with an at least partially or at least locally porous material structure, for example as a filter element or filter device, comprises several steps. In the step of providing a porous or porosable base material, the base material is provided for application. In one example, the base material is provided by means of an extruder. The base material is already porous or it is provided in a porosable form. This means that the base material is initially non-porous when it is provided, but is influenced, changed or differently composed in connection with the application of the base material in such a way that the base material can be interspersed with pores in a temporal connection with the application of the base material.

In other words, providing the porous or porosable base material means transferring a primary material to the component being manufactured. Thus, providing may also include conveying the porous or porosable base material to the location of the material application. Provisioning may also include thermal adjustment to desired application conditions, as well as setting an advantageous physical pressure at the moment of application of the feedstock material to produce the component. In the extruder example, providing includes conveying and pressing in the extruder screw, with the porous or porosable base material finally being provided at the exit of the extruder.

The method according to the specification further comprises applying the porous or porosable base material to build up the component. When applying, the method also comprises adjusting the porosity of the porous or porosable base material. In other words, in connection with the material application of the base material to or onto the component, the porosity is adjusted at the location of the material application. For example, this adjustment takes place in time immediately before, during or immediately after the specific material application. Here, for example, machine parameters of an application machine can be changed, such as of an extruder, or a mixing ratio of the base material can be changed, or process parameters can be adjusted during the solidification of the base material in order to adjust the porosity at the location of the material application. The material permeability is adjusted to provide the appropriate filtration performance. This means that a similar or better filter performance can be achieved than with conventional filter modules, and at the same time the production can be considerably more flexible and/or cost-effective, or materials can be used which previously could only barely be used for the production of filter modules because their processability was not given or it could not even be recognized without the new production process that corresponding filter performances could be achieved with them.

For example, a low or non-porous material can be provided in this way to build up parts of the housing of the component. With the same base material but different physical parameters or different composition or different additives, a porous material structure can be created elsewhere in the component. The various component areas, such as the housing and porous material structure in the aforementioned example, are monolithically constructed, i.e., in one piece with each other. It is thus characteristic that no conventional component-to-component transitions occur, but rather areas of the component with different porosities can be built up, with all areas being manufactured together from a single piece and typically being materially bonded to one another, i.e., for example, fused, baked, sintered or glued. The process is continued until the component is manufactured as a whole. For example, the process is continued without interruption or pause, so that the additive manufacturing process is carried out in one run. For example, an advantageous application temperature can thereby be kept constant or maintained in a material application zone, so that there is a continuous material application for manufacturing the component. Thanks to the monolithic structure of the components of the component previously provided as separate parts, bonding, potting and/or sealing between the components previously provided as separate parts can be dispensed with in an advantageous manner. It is precisely these bondings, potting compounds and/or sealing elements that have in some cases severely limited the service life or the range of use (temperature ranges, pressure ranges, chemical resistances, etc.) for the component.

In an advantageous embodiment, the additive manufacturing process for producing a component may comprise applying the porous or porosable base material in a point-by-point, line-by-line or layer-by-layer manner. In other words, the base material is preferably applied point by point, for example in a point-target matrix point by point, the material application being successive. The material application can nevertheless be continuous or quasi-continuous, i.e., for example, “caterpillar-like”, and still approach a point-target matrix point by point, which can be described as quasi-continuous material application.

It is not necessary and typically not intended that material is applied at every point of the point-target matrix. Thus, points are provided in the point-target matrix which are not approached and such points which are approached and where base material is applied. The material is typically applied under gravity from bottom to top, wherein a bottom layer is first deposited on a component carrier, whereby the bottom layer can be applied in points, lines or layers. The bottom layer is also not necessarily a continuous layer, but can rather comprise areas with and without material application.

The material can be applied advantageously in a layer-target matrix. In this way, a plurality of points to be approached can be combined in such a layer. Layers of the layer-target matrix are arranged, for example, one above the other at a distance from one another that is equidistant, for example. The material application can also be prepared layer by layer and an entire layer can be bonded or crosslinked as a unit, for example if the base material is in powder form, it can first be deposited layer by layer and a layer can be prepared as a whole, for example heated with a radiation source and bonded together as a single piece.

Layers as well as points can also be provided in other coordinate systems, such as cylindrical coordinates, if, for example, a tubular structure is to be manufactured as a component. In this description, the point-target matrix is understood as the best possible resolution or subdivision of the component to be manufactured in spatial coordinates, since this describes the smallest possible subdivision of the component to be manufactured. The point spacing from one point to the next adjacent point does not have to be identical; rather, it can be advantageous to vary the point spacing, to vary it within one direction depending on the application and/or to express it differently in different directions of the coordinate system. For example, an area of particularly complex geometry can thus be provided with a narrower point pitch, whereas simple structures can be described with a small number of points. This is quickly understandable, for example, in the case of paste-like base material, when the base material is applied in a “caterpillar-like” manner, and a long straight layer is applied, where only the starting and end points of the straight layer would have to be defined. However, equidistant point-target matrices may also be advantageous, if necessary. The layer-target matrix, in turn, typically comprises target points in each application layer into which the component to be manufactured and, if necessary, intermediate spaces or cavities of the component to be manufactured are divided.

The point-by-point application can comprise the approaching of a point of the point-target matrix at which the porous or porosable base material is to be applied. The term “approaching a point to be approached” can be used in a variety of technical ways. Basically, approaching a point to be approached means that base material is provided in such a form and manner that it is available at the corresponding point of the point-target matrix. The approach can thus be carried out by means of an application tool. Such an application tool can be the already mentioned extruder, whereby the application tool can be moved in a three-dimensional manner to the point of the point-target matrix to be applied, or a component carrier is designed to be adjustable in such a way that a movable system of the point-target matrix is created, wherein the point-target matrix is displaced in front of the application tool and the point of the point-target matrix to be applied comes into contact with the application tool.

An application tool is preferably used when the base material is in liquid, paste or solid form. In the event that the base material is in powder form, the approaching of the point of the point-target matrix to be approached can also be understood, for example, as the directing of a heat generator, such as a laser or radiation source, onto the point of the point-target matrix to be approached, in order to bring the powdery base material deposited there at least into a kind of premelt at the point of the point-target matrix, so that it joins into the surrounding component or the surrounding base material, for example as preparation for a later sintering of the component as a whole. For example, the powdery base material can be a filled polymer powder filled with anorganic components, such as ceramic and/or metallic filler components.

In general, approaching a point of the point-target matrix to be approached means changing, preparing or positioning the point of the point-target matrix to be approached in such a way that the base material can be integrally joined into the monolithic component as a one-piece component at the point to be approached.

During the application at the point to be approached, the porous or porosable base material is preferably adjusted, namely at the point of the point-target matrix to be approached. The adjustment of the porous and/or porosable base material can also take on different forms. For example, the adjustment of the porous or porosable base material means the adjustment of a mixing ratio in the base material, if for example a filler is provided in a variable mixing ratio, where the mixing ratio of the filler defines the porosity of the base material. Adjusting the base material at the point to be approached of the point-target matrix can also be realized by adjusting the radiation source or the source for a thermal treatment of the base material at the point to be approached. For example, the intensity of a laser to be used can be adjusted so that a higher intensity produces a different porosity than a lower intensity.

The examples mentioned have in common that the base material is influenced, changed, composed or generally adjusted with regard to its porosity at the point of the point-target matrix to be approached. The porous or porosable base material adjusted in this way is preferably applied at the point.

The additive manufacturing method for manufacturing a component may further comprise the step of approaching at least one first point of the point-target matrix and adjusting the porous or porosable base material at the at least one first point such that a porous material structure is formed at the at least one first point. In other words, the base material is adjusted at the at least one first point, for example at a plurality of points forming a common region in the component, such that a porosity in the component is adjustable in an additive manner. Thus, by approaching the point or points of the point-target matrix, a porous material structure is successively built up.

The method may also comprise the step of approaching at least one second point of the point-target matrix and adjusting the porous or porosable base material at the at least one second point such that an impermeable material structure is formed at the second point. In other words, adjusting the base material at the second point or points, which form, for example, a region in the component, such that the resulting structure has an impermeable structure. Impermeable in this context is, for example, a structure which has comparatively few pores or no pores at all, or which has a closed-pore structure, so that no fluid exchange and/or particle transfer between fluids is ensured. An impermeable structure in the meaning of the specification thus preferably prevents a fluid from flowing through the impermeable material structure; and further, i.e., prevents the particle transfer of a first fluid on a first side of the impermeable material structure with a second fluid on a second side of the impermeable material structure. An exemplary structure which can be advantageously constructed with an impermeable material structure is an enclosure around the component for the protection thereof, as well as for the purpose of holding, in particular, an enveloping fluid in the component and at the same time providing an enveloping side for the enveloping fluid.

The points of the point-target matrix can be arranged in deposition layers. In this case, the point-target matrix can be approached in layers, so that first the points of a first deposition layer are approached, whereby not all points of the first deposition layer have to be approached. Subsequently, i.e., after the first deposition layer has been approached, points of a second deposition layer are then approached, whereby it is again not necessary for all points of the second deposition layer to be approached; rather, it is intended to provide cavities in contiguous form in the component.

The step of applying may comprise applying the porous or porosable base material in such a way that at least one deposition layer has areas with impermeable material structure. The applying step may also be configured such that at least one deposition layer has regions with a porous material structure.

The deposition can further be designed such that at least one deposition layer has both impermeable material structure and porous material structure, which is deposited with the same porous or porosable base material. In other words, both impermeable material structure and porous material structure can be built up in a deposition layer using the present method. The basic idea of the present invention remains that all areas are monolithically, i.e., integrally, connected to each other. In the context of the present specification, it could be realized that areas with impermeable material structure are built up in one piece together with areas with porous material structure. This can be achieved by adjusting the base material at the point to be approached.

The application of the porous or porosable base material can be carried out in such a way that the partially or locally porous material structure of the component is chaotically arranged or built up. In other words, the porous material structure has a chaotic arrangement or structure. Chaotic in this context means that the exact microporous structure obtained with the application of the porous or porosable base material is not reproducible in its microporous configuration so exactly that one component resembles a second component at a specific point of the point-target matrix. Rather, the idea of the present invention, at least in one aspect, is that the pore structure is not precisely determined in the micrometer range, but is merely adjusted with respect to its effect. Thus, an achievable pore size can in principle be set in the material application, but not the exact arrangement and structure of the pores achieved. With regard to the technical effect, this is neither a difference nor a disadvantage. On the contrary, this aspect has the advantage that the exact modeling of each individual pore can be dispensed with and only a desired porosity is set. The actual arrangement of the pores relative to each other is not important. The porosity generated and provided in this way can therefore be described as intrinsic porosity. The inventors have recognized that it is sufficient and particularly advantageous to provide such an intrinsic porosity, since components can be produced considerably faster and at the same time more economically than with known processes.

The idea of adjusting the porosity of the base material—as opposed to modeling each individual pore—can also be used for wet-precipitated flat membranes or polymer capillary membranes (NIPS) Likewise, this can be used in such a process, for example, for polymer membranes produced by thermally induced phase inversion or separation (TiPS).

The partially or locally porous material structure of the component may be formed with the application of the base material in or on the component and may have a non-repetitive structure, i.e., a “chaotic” or “non-deterministic” structure or arrangement. In this regard, as previously described, the structure or arrangement of the porous material structure is not repeatable in such a way that an identical pore arrangement could be achieved by repeating the component fabrication. Rather, with respect to a comparison to the first component, a second component will have a comparable porosity at a specific point of the point-target matrix, whereby the porosity is set or adjustable in the process according to the invention, but not the exact pore distribution and arrangement in the component. The base material can therefore preferably be set or prepared to be intrinsically porous. In other words, it is particularly advantageous to use the process according to the invention or the application machine according to the invention to not set the position of each pore exactly, but the porosity in a material structure.

The porous material structure preferably has an open porosity. The impermeable material structure, on the other hand, may have closed porosity or no porosity at all, or in any case no open porosity.

The porous material structure can be characterized by the fact that it is at least partially permeable to the fluid or at least to components of the fluid. The porous material structure can be characterized by the fact that there is less resistance to the flow or penetration of a fluid through the porous material structure than in the impermeable material structure. It may prove advantageous if the pores are formed at least partially interconnected, so that a fluid can flow from one pore to the next and a flow through the porous material structure can be formed overall. Thus, open porosity preferably means that a pore is typically in communicating fluid exchange with at least two other pores as a fluid flows through the porous material structure. In this regard, the fluid may be caused to flow by conveying the fluid through the component with the application of a pressure gradient, for example generated by gravity and without an external pumping device, or even by the action of a pumping device.

The porous material structure can have an open microporous or mesoporous structure. The average pore size can be smaller than 40 μm, preferably smaller than 5 μm and more preferably even smaller than 1 μm. Such average pore sizes have not yet been achieved with comparable processes.

The porous material structure preferably has an average volume porosity of 20% or greater, preferably 35% or greater. Depending on the manufacturing process, the average volume porosity can even reach 50% or greater values.

The impermeable material structure may have a higher density than the porous material structure. The ratio of the density of the impermeable material structure to that of the porous material structure is in particular 1.2:1, preferably 1.5:1 and even more preferably 2:1. In other words, the material structure in impermeable regions has a denser structure than in regions of porous material structure. In this context, the ratio of the density of the impermeable material structure to the porous material structure may also be given in intervals, for example in an interval between 1.2:1 to 1.5:1 and preferably in the interval from 1.5:1 to 2:1.

The step of adjusting the porosity of the porous or porosable base material can, for example, comprise the admixture of additive or filler to the base material to adjust the porosity at the moment of material application. In particular, this is performed at the actual point of the point-target matrix to be approached. The adjustment can also include the setting of curing parameters for the respective point of the point-target matrix to be approached.

The step of setting may further comprise selecting one base material to be applied from a plurality of at least two base materials, wherein the at least two base materials may be supplied alternately or simultaneously. For example, this may be configured such that the at least two base materials are provided at the respective point of the point-target matrix to be approached to produce the monolithic component.

The step of setting may also comprise providing a location-dependent radiation intensity with a radiation source directed on the material application, i.e., on the point of the point-target matrix to be approached. Alternatively, the step of adjusting may comprise the location-dependent adjustment of the light absorption capability of the porous or porosable base material, so that the component build-up can be carried out, e.g., by means of a location-independent radiation source.

Polymeric or inorganic nanoparticles can be used as additives. Nanoparticles are defined as particles with an average diameter of typically 100 nm or less. For example, the nanoparticles may have an average diameter of 900 nm or less, 500 nm or less, 100 nm or less, or even 50 nm or less. The filler may be an inorganic or organic filler.

The pores of the porous or porosable base material can be designed or prepared during material application, i.e., at the specific time and location of the point of the point-target matrix to be approached, so that they form a coherent porous material structure in the component.

The pores can also be provided so that they have a rounded or potato-shaped individual structure.

The porous material structure of the component may be constructed and/or arranged such that it is suitable for permeably separating an shell side from a carrier side. In other words, the component is prepared such that the porous material structure forms an shell side on its first side and forms a support side on its second side. For example, the porous material structure may be referred to as a membrane, wherein the membrane has two flat sides and the first flat side is in contact with a shell fluid, wherein the second flat side is in contact with a carrier fluid.

Within the scope of the specification, a monolithic component is also described, for example as a device for separating components from a fluid, further for example manufactured according to the method as described above. The monolithic component comprises a first end face and a second end face opposite the first end face. A porous structure is disposed between the first end face and the second end face, the porous structure being integrally constructed and connected to the end faces. The porous structure is arranged to be permeable at least locally or at least partially.

The porous structure is further adapted and arranged to permeably separate a shell side from a carrier side at least partially and/or at least locally. A carrier fluid can be provided on the carrier side.

The porous structure is designed to ensure a transfer of substance of the carrier fluid with the shell side. A mass transfer is, for example, a transfer from the carrier fluid into a shell fluid and/or from a shell fluid into the carrier fluid.

The monolithic component can be designed as a membrane element for a filter device or can be designed as a filter device as a whole. The filter device is then monolithically constructed with the porous structure as the membrane element.

The monolithic component may further comprise an enclosure formed monolithically with the porous structure and the first and second end faces. The porous structure is thereby preferably enclosed by the enclosure together with the first and second end faces.

A shell fluid can preferably be provided on the shell side of the monolithic component, so that both the carrier fluid and the shell fluid can flow in or through the monolithic component. The carrier fluid is then separated from the shell fluid by means of the porous structure. The monolithic component can also be provided such that the porous structure is set up to be semi-permeable or selectively permeable.

With regard to the porous structure, the monolithic component can be prepared such that it is set up for substances and/or particles with a size smaller than 10 μm, preferably smaller than 2 μm and further preferably smaller than 0.5 μm, for which the porous structure is set up to be permeable, semi-permeable or selectively permeable.

The monolithic component may be adapted to receive and discharge the carrier fluid on the carrier side and a shell fluid on the shell side. The carrier fluid as well as the shell fluid may then flow through the monolithic component to provide a carrier flow and a shell flow in the monolithic component.

The porous structure of the monolithic component may include filter capillaries, especially membrane capillaries.

The first end face of the monolithic component can be plate-shaped. The porous structure is integrally formed on the first end face, i.e., integrally formed together with the first end face. The porous structure is then monolithic, i.e., integrally formed with the first end face. Particularly preferably, the first end face and the porous structure are made of the same material.

The second end face can also be plate-shaped. As described before with regard to the first end face, the porous structure can be integrally formed on the second end face, e.g., integrally formed with the second end face.

The porous structure may include a plurality of elongated membrane tubes or filter capillaries. The membrane tubes or filter capillaries connect the first face of the monolithic component to the second face as a one-piece component and, preferably, integrally

The membrane tubes or filter capillaries preferably have an inner side. The inside of the membrane tubes or filter capillaries forms the carrier side. The carrier fluid can therefore flow along the inside. Membrane tubes or filter capillaries are preferably tubular, so that the carrier side is formed in the tubular structure and the carrier fluid flows there.

The membrane tubes or filter capillaries preferably form the shell side on their outer sides. The shell fluid can therefore flow along the outside.

The membrane tubes or filter capillaries typically have a tubular or tubularly shaped design. The diameter of the tubular configuration may vary along the length. Preferably, the membrane tubes or filter capillaries have a substantially straight tubular extension.

In a preferred embodiment, the membrane tubes or filter capillaries are designed in a stress-tolerant manner, for example stress-tolerant regarding longitudinal tension forces, or, as the case may be, stress-tolerant regarding transverse tension forces. If the first end face and the second end face are arranged parallel to each other, a longitudinal stress can imply a force application to the membrane tubes or filter capillaries, during which the end faces remain arranged parallel to each other, but are possibly displaced parallel to each other; a longitudinal stress increasing above a certain level can thus result in an evasive movement of the end faces towards each other. In this process, the membrane tubes or filter capillaries are subjected to force along their main extension direction, i.e., they are typically compressed, but may also be elongated. The membrane tubes or filter capillaries may break. A transverse stress may imply that a force is applied to the membrane tubes or filter capillaries in which the end faces are tilted towards each other, i.e., a force is applied perpendicular to the main extension direction of the membrane tubes or filter capillaries. If the membrane tubes or filter capillaries are equipped with stress tolerance, then they can be subjected to a higher degree of longitudinal stress and/or transverse stress than a comparable straight membrane tube or filter capillary. In other words, for example, the geometry of the membrane tubes or filter capillaries is constructed in such a way that a higher longitudinal stress, or transverse stress, can be absorbed without rupture of the membrane tubes or filter capillaries following. One embodiment for a membrane tube or filter capillary, which is equipped to be stress tolerant, is a spring-like compressible membrane tube or filter capillary. For example, the membrane tube or filter capillary can be compressed by 1 mm or more without damaging or destroying it, preferably by 2 mm or more, more preferably by 5 mm or more, still more preferably by 10 mm or more, finally preferably by 20 mm or more. On the other hand, the length change tolerance—that is, the length change that results when stress is applied due to the stress tolerance of the membrane tube or filter capillary—can be 0.1% of the original length or more, preferably 0.2% or more, further preferably 0.5% or more, still further preferably 1% or more, and finally 2% or more of the original length of the membrane tube or filter capillary.

Stress-tolerant can also be understood as elastic, stress-distributing or stress-reducing, because stress peaks in inelastic areas are distributed over a larger component area, but may even be reduced overall if the component allows deformation as a result. It is preferred that the membrane tubes or filter capillaries are designed to dissipate stress, because if the membrane tubes or filter capillaries can yield when subjected to force, e.g., compress like a spring, and at the same time the component housing is sufficiently rigid, then the stress applied, e.g., the compressive stress, can be dissipated to the component housing and absorbed by it.

The membrane tubes or filter capillaries can be spirally or helically extended, for example as a double helix or triple helix, in which two or three membrane tubes or filter capillaries run around each other. Such a spiral or helical extension of the membrane tubes or filter capillaries has several advantages. For example, substance transfer on the inside of the membrane tube or filter capillary is intensified; resistance to external mechanical influences, such as a shock or torsion of the component, is also improved. This represents a suitable design for equipping the membrane tubes or filter capillaries with stress tolerance, as described above.

The membrane tubes or filter capillaries preferably each have a first or second orifice through which a fluid can flow. The orifice is preferably integral with the first or second end face. In other words, the first or second end face merges integrally from a planar extension into the orifice.

The orifice can have a flow-conducting surface design. The flow-conducting surface design reduces flow resistance for a fluid flowing through it, for example by avoiding or reducing turbulence and/or pressure fluctuations in the flow path. Such a flow-conducting surface design of the orifice can have, for example, a cone-shaped, cone-jacket-shaped, parabolic or torus inner surface design. For example, the flow-conducting surface design is arranged or constructed concentrically around the orifice and is integrally recessed into the first or second end face. In other words, the orifice integrally merges with the first or second end face.

The monolithic component may further comprise a first carrier fluid collection port monolithically formed with the first end face and the porous structure. For example, the first carrier fluid collection port is an inlet for the carrier fluid.

The monolithic component may further comprise a second carrier fluid collection port monolithically configured with the second end face and the porous structure, that is, e.g., a drain.

Further, the monolithic component may include a shell fluid port monolithically formed with the porous structure. The shell fluid port may also be monolithically formed in conjunction with the porous structure via the first and second end faces, respectively.

The porous structure may include at least one connection, cross-connection, or stiffener monolithically formed with the porous structure to increase the mechanical stability of the porous structure.

The connection, cross-connection or stiffener may directly and integrally connect the porous structure to the enclosure. In other words, the connection, cross-connection, or stiffener may be arranged to directly and immediately connect the porous structure to the enclosure, thus being arranged between the porous structure and the enclosure. The connection, cross-connection or stiffener may also connect porous structures to each other, for example when a plurality of porous structures together define a filter element.

The porous structure may include at least one turbulator for mixing the carrier fluid and/or for mixing the shell fluid. A turbulator may provide turbulence in the corresponding fluid so that there is improved mixing and thus substance transfer between the shell fluid and the carrier fluid.

The porous structure can provide a flow cross-section that varies along its length for the carrier fluid and/or the shell fluid.

The porous structure may comprise a higher or lower porosity and/or pore width distribution, for example locally or in parts of the porous structure. The porous structure may have impermeable regions, permeable regions, and further regions having a different porosity compared to both the impermeable regions and the permeable regions. Such further different region of porosity may be materialized such that, for example, inside the membrane capillaries, a kind of coating is executed on the inner surface. The coating may be monolithically applied from the same base material.

The first and/or the second end face has an integral fluid barrier or is designed as an integral fluid barrier, the fluid barrier separating the flow of the carrier fluid from the shell flow. In an advantageous manner, the use of potting compound is completely avoided here, so that accompanying disadvantages are eliminated.

The monolithic component is preferably constructed as a whole from the porous or porosable base material.

The porous or porosable base material preferably has inorganic, e.g., metallic and/or ceramic, constituents. Such inorganic constituents may be provided as an inorganic paste, for example a ceramic paste. The base material may further comprise polymers, for example provided as polymer powder, comprising for example polypropylene or polyvinylidene fluoride (PVDF) or polyethersulfone (PES), polysulfone (PSU), polyimide (PA), polyacrylonitrile (PAN), peloyetheretherketone (PEEK), polyethylene terephthalate (PET) or the like. Thus, the base material may comprise, in the form of polymers, at least one of polyolefins, for example, polypropylene, polyamides, polyvinylidene fluoride (PVDF), and polyethersulfone (PES). The base material may also comprise a polymer-solvent mixture, for example, in molten form. The porous or porosable base material may further be provided as a polymer solution with inorganic fillers, for example ceramic, metallic and/or polymeric fillers. In other words, the base material may comprise ceramic, metallic and/or polymeric constituents, optionally in a mixing ratio to each other.

The specification also includes a monolithic component manufactured by a process as described above.

The specification further describes a monolithically constructed filter module for a device for separating constituents from a fluid. The monolithically constructed filter module comprises a first end face and a second end face opposite the first end face. The filter module further comprises a filter housing, for example elongated or tubular, formed integrally with the first and second end faces.

The filter module also has a porous structure arranged in the filter housing and integrally constructed and connected to the end faces and the filter housing. The porous structure is thereby arranged to be permeable, at least in part or locally. The filter module further comprises at least one carrier fluid collection port and at least one shell fluid port.

The first end face and the second end face of the filter module are each formed as an integral fluid barrier for preventing cross flow between the carrier fluid collection port and the shell fluid collection port.

The porous structure is designed and arranged to permeably separate a shell side from a carrier side at least partially and/or at least locally.

A carrier fluid can be provided on the carrier side. The porous structure is designed to ensure substance transfer of the carrier fluid with the shell side.

In the following, the invention will be explained in more detail by means of embodiment examples and with reference to the figures, whereby the same and similar elements are partially provided with the same reference signs and the features of the various embodiment examples can be combined with each other.

### BRIEF DESCRIPTION OF THE DRAWINGS

FIGS. 1, 1a, 1b are perspective views of a monolithic tube bundle as a component with detail sections;

FIGS. 2, 2a, 2b illustrate a monolithic component in sectional view;

FIGS. 3, 3a, 3b illustrate a monolithic component with housing;

FIGS. 4, 4a, 4b illustrate a monolithic component as insert module;

FIGS. 5, 5a, 5b illustrate a monolithic component as a filter module;

FIGS. 6, 6a are perspective views of a monolithic component with bars;

FIGS. 7, 7a, 7b illustrate a monolithic component as cartouche with bars as detailed view;

FIG. 8 illustrates a monolithic component with membrane tubes arranged in triple helixes in perspective view;

FIG. 8a illustrates a segment of a membrane tube bundle arranged in triple helix;

FIGS. 9a, 9b, 9c are displays of a segment of a meander-shaped membrane tube;

FIGS. 10 to 10e illustrate a monolithic component with variable diaphragm tube diameter;

FIGS. 11-11e illustrate a further example of a monolithic component with variable tube geometry;

FIGS. 12a-12e illustrate a monolithic component with internals or internal structures (static mixers);

FIGS. 13-13b illustrate a monolithic component with applied coating;

FIGS. 14-16 are representations of various piles which can be produced using the processes are achievable;

FIG. 17 is an example schematic for various process sequences for the production of a monolithic filter module;

FIG. 18 illustrates an application device for applying powdered base material;

FIG. 19 illustrates a heating furnace for the pretreatment of solid base material;

FIG. 20 illustrates a mixing device;

FIG. 21 illustrates a further application device with feeder;

FIG. 22 illustrates a plant with two selectable application devices;

FIG. 23 illustrates a plant with excitation or activation arrangement;

FIG. 24 illustrates a setting the location-dependent light absorption capacity;

FIG. 25 illustrates a further application device;

FIG. 26 illustrates another example of an application device;

FIG. 27 illustrates a combustion chamber with green body;

FIG. 28 illustrates a wash bath for washing out production aids; and

FIG. 29 illustrates a flushing device.

### DETAILED DESCRIPTION OF THE DRAWINGS

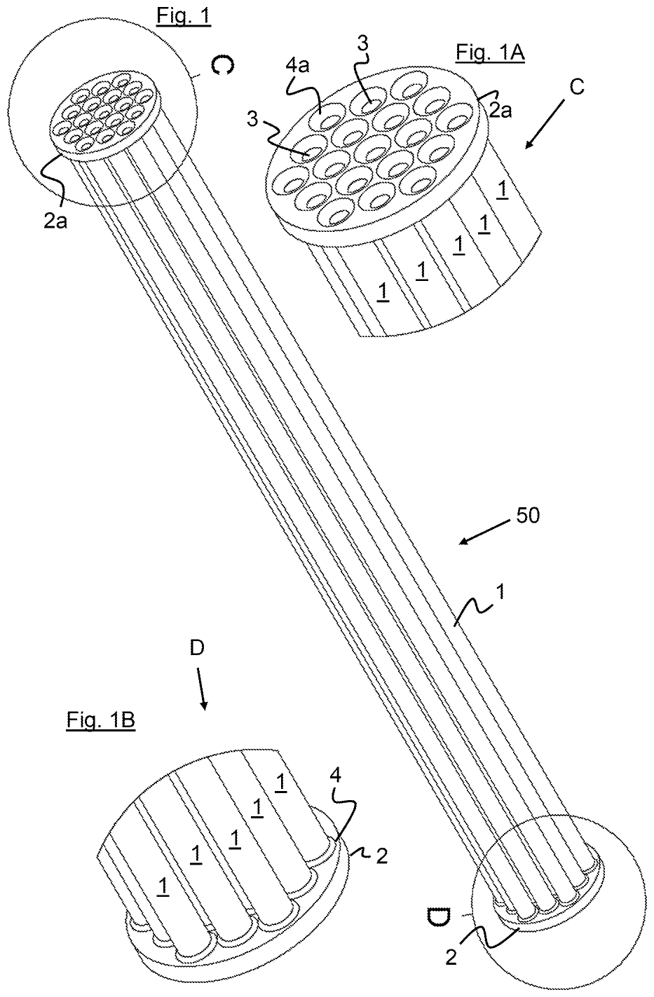

Referring to FIG. 1, a first embodiment of a monolithic component 50 is shown, which has a first end face 2 and a second end face 2a as well as a bundle of membrane tubes 1. The two end faces 2, 2a are integrally constructed with the membrane tubes 1 and are directly connected. The diaphragm tubes 1 and end faces 2 are manufactured successively in one process step. For example, a subsequent connection by joining, welding, gluing, clamping or the like is not required or not produced. The end faces 2 and membrane tubes 1 are made of the same, similar, or at least compatible material, so that end faces 2 and membrane tubes 1 can be constructed in one piece. The membrane tubes 1 have membrane inlets 3 which merge into the respective end face 2, 2a. The membrane inlets 3 are therefore at the same time part of the respective membrane tube 1 as well as part of the respective end face 2, 2a. In this example, the diaphragm inlets 3 therefore also represent the respective connection point between the diaphragm tube 1 and the end face 2, 2a, so that mechanical forces can also act on the diaphragm inlet. The membrane inlet 3 can thus be designed to be optimized in terms of mechanical stability in order to reduce the tendency to break in the area of the transition from the end face 2, 2a to the respective membrane tube 1. The membrane tubes 1 together form the membrane or membrane filter 60a.

FIG. 1a shows a detail section on the end face 2a as shown in FIG. 1. The diaphragm inlets 3 have a hydraulically optimized rounded design with a rounded funnel area 4a. The rounded transitions 4a from the diaphragm tubes 1 to the end faces 2, 2a also ensure a mechanically favorable coupling of the diaphragm tubes 1 to the respective end faces 2, 2a.

FIG. 1b shows a detailed section of the end face 2, with the rounded transitions 4 visible from its exterior in the perspective view.

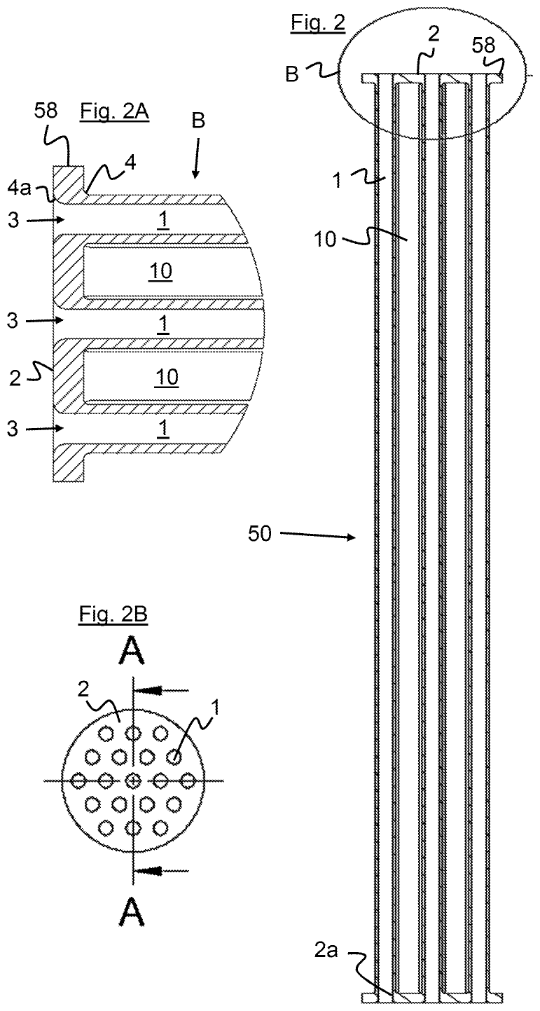

FIG. 2 shows a cross-sectional view in a longitudinal section through the monolithic component 50 along the line marked A-A in FIG. 2b.

FIG. 2b shows a top view of the end face 2 of the monolithic component 50. FIG. 2 shows three cut-open membrane tubes 1 as well as the hollow spaces forming the shell side 10 located between the membrane tubes. The end faces 2, 2a have a connection collar 58, for example in order to couple the monolithic component 50 to a further connection piece (not shown).

FIG. 2a shows detail “B” from FIG. 2, with the diaphragm inlets 3 of the face 2 shown more clearly. Between each diaphragm tube 1 to the next diaphragm tube 1 is the shell side 10. The diaphragm inlets 3 are rounded to improve the mechanical load capacity, as well as the flow pattern, at this point.

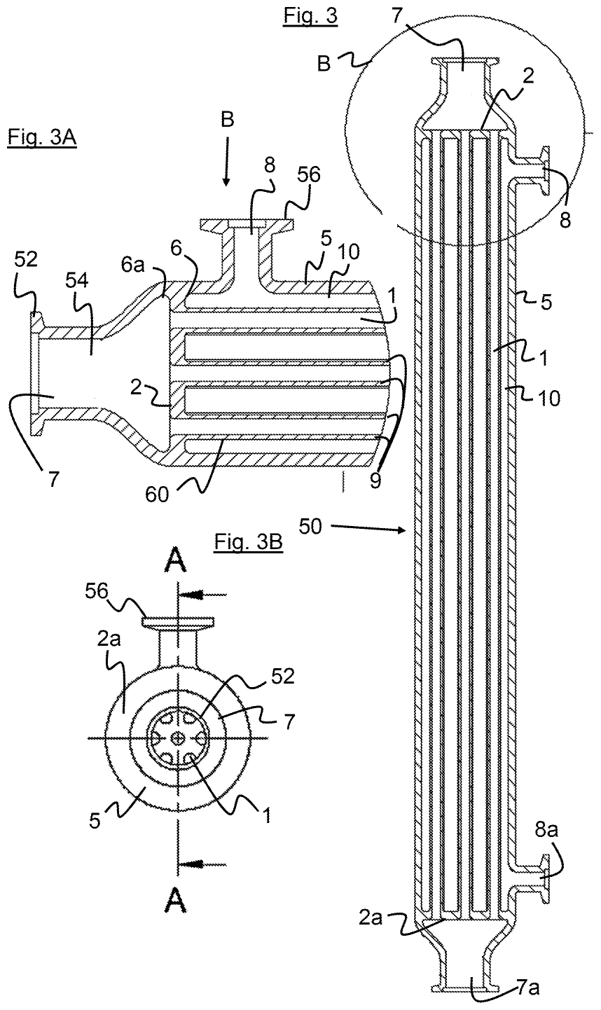

With reference to FIG. 3, a monolithic component 50 is shown with an inlet 7 and an outlet 7a at the respective end face 2, 2a of the monolithic component 50. Membrane tubes 1 extend from the end face 2 to the end face 2a and connect the two end faces 2, 2a in one piece. Furthermore, the monolithic component also has an outer side 5, in the form of an enclosure 5, which also seals off the enveloping side 10 from the environment, for example in a fluid-tight manner, if one disregards the connections provided on purpose for the shell fluid inlet or shell fluid outlet 8, 8a.

FIG. 3b shows a top view of the filter 50 shown with FIG. 3, with the line A-A illustrating the sectional plane in which FIG. 3 is shown as a sectional view. A shell fluid collection port 56 is arranged on one side of the monolithic component 50 as an inlet or outlet for the shell fluid. The shell fluid collecting connection 56 can be designed as a flange, so that a connecting line for the shell fluid can be connected there, for example by means of a screw connection. A carrier fluid collecting connection 52 is arranged on one longitudinal side, for example on the inlet 7, which can also be designed as a flange for the screwed or clamped connection of a connecting line for the carrier fluid.

FIG. 3a shows detail “B” of FIG. 3, further clarifying the structure of the inlet 7. The inlet 7 forms a carrier fluid chamber 54, in which the carrier fluid is supplied to or discharged from the individual membrane tubes 1 communicating with the carrier fluid chamber 54. The inlet 7 is formed integrally with the end face 2 and integrally with the housing 5 and the membrane tubes 1. The membrane tubes 1 are thereby formed in that the side walls 9 of the membrane tubes emerge in one piece from the end face 2 and are extended to form a tubular structure. Inside the membrane tube 1, that is, on the inside of the side surface 9 of the membrane tube, the carrier fluid can flow through to pass from one end face 2 to the opposite end face 2a. In other words, the carrier fluid typically flows from the end face 2 to the end face 2a (or in the reverse direction), with no direct fluid dynamic communication between the carrier side and the shell side, or, if possible, it is prevented. Rather, the side surface 9 of the membrane tube provides a porous surface to ensure substance transfer between the shell fluid on the shell side 10 and the carrier fluid in the membrane tube 1. The side walls 9 of the membrane tubes 1 therefore form the porous structure 60, which is designed to be permeable, semi-permeable or selectively permeable. The transitions 6, 6a between housing 5 and membrane end plates 2, 2a are also rounded. A subsequent or non-material connection by joining, welding, bonding, clamping or the like is not required in a particularly advantageous manner. End faces 2, 2a and housing 5 are preferably made of the same, or at least compatible, material in order to ensure the monolithic structure of the component 50.

The fluid to be separated, or the carrier fluid, enters the housing 5 via the inlet 7, and there more precisely into the membrane tubes 1. It enters the respective membrane tube 1 via the membrane inlet 3, flows through the membrane tubes 1 from their first side to their second side, and at the other end of the housing the fluid exits again at the opposite end face 2a. The filtrate penetrates the walls 9 of the membrane tubes 1, i.e., through the porous structure 60, is collected in the filtrate chamber 10, if applicable, and can leave the housing via one of the filtrate connections 8.

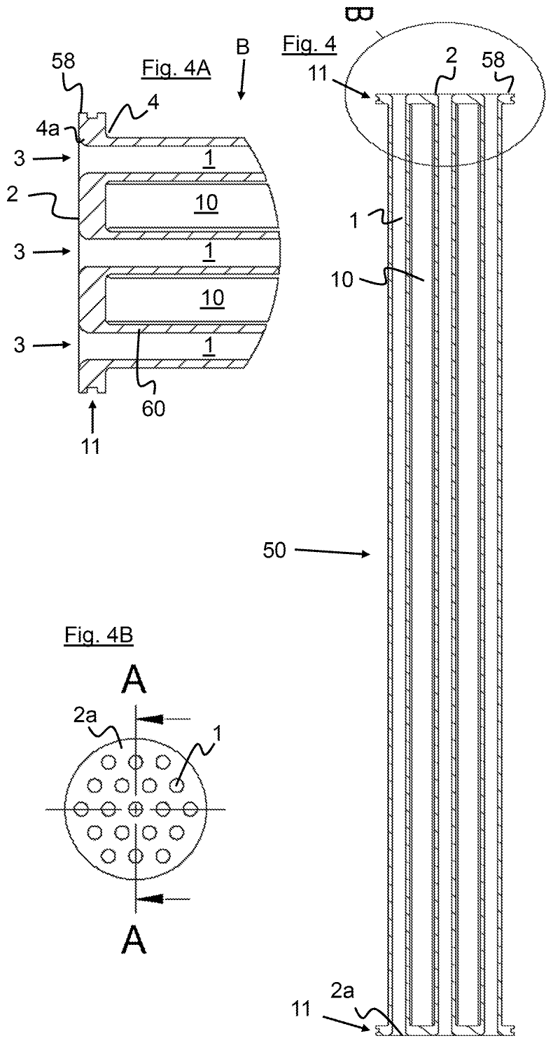

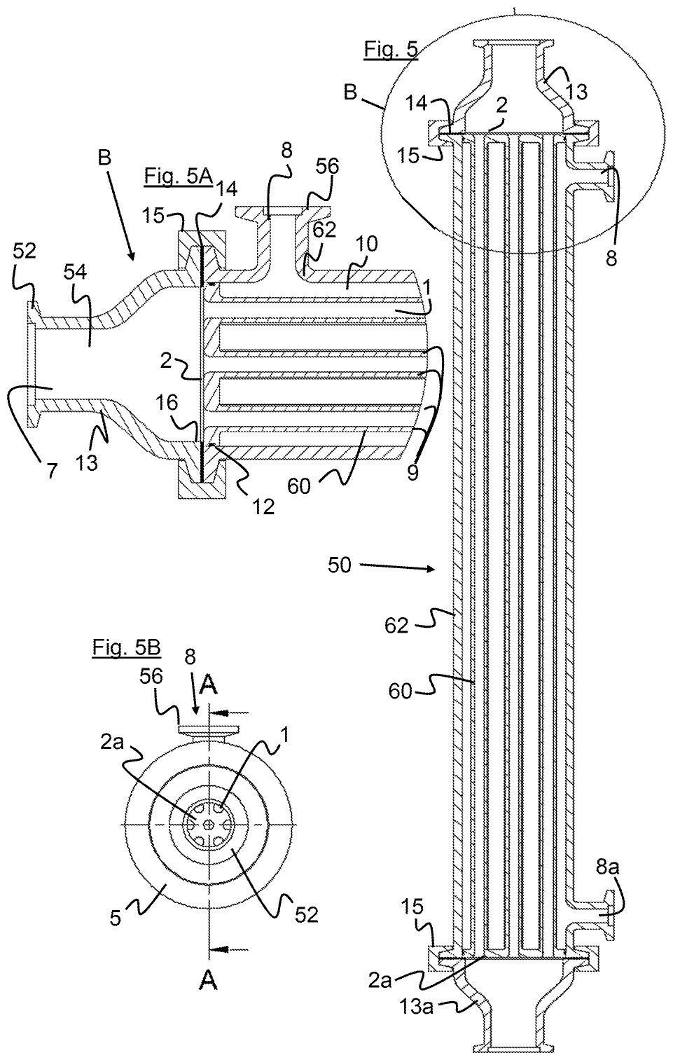

Looking at FIG. 1 together with FIG. 3, it becomes clear that a membrane tube bundle 1a according to FIG. 1 can also be designed as a porous structure 60 as an insert for a separate housing 62, as further specified, for example, with FIGS. 4 to 5.

As can be seen in FIG. 4, a groove 11 can be provided on the end faces 2, 2a for a possible seal. In this example, at least the membrane tube bundle 1a consisting of the plurality of membrane tubes 1 is formed integrally with the end faces 2, 2a, so that the separation of the carrier fluid from the shell fluid is completely ensured by the monolithic component 50 and the susceptible potting compound can be dispensed with here. This already represents a significant further development compared to the known dialysis filters.

FIG. 4a shows detail “B” from FIG. 4, further illustrating the structure with the groove 11 in the connection collar 58. The connection collar 58 is shown rounded out with the fillets 4, 4a as shown in detail with reference to FIG. 1.

FIG. 4b shows a top view of the second end face 2a, with line A-A indicating the sectional plane for FIG. 4.

Referring to FIG. 5, a further embodiment of the monolithic component 50 is shown, which has the two end faces 2, 2a formed integrally with the porous structure 60. An inlet piece 13 and an outlet piece 13a are flange-mounted by means of a clamping ring 15. The housing 62 is designed as a separate component which is slipped over the porous structure 60 in the form of a tube.

FIG. 5b shows a top view of the face 2a for this purpose, with the section line A-A illustrating the section plane of FIG. 5. The carrier fluid collection port 52 is arranged concentrically to allow a feed line with the porous structure 60 and thus with the filter element consisting of the membrane tubes 1.

FIG. 5a shows detail “B” from FIG. 5, showing an exemplary structure for connecting the monolithic component to the inlet piece 13. The separate housing 62 is sealingly applied to the flat sealing element 14 via the sealing element 12 and is clampingly connected to the feed piece 13 by means of the clamping ring 15. An overhang 16 of the feed piece 13 improves the axial fixation of the diaphragm tube bundle 1 in the separate housing 62. The clamping ring 15 can be subjected to an appropriate contact pressure force to create a sealing connection between the separate housing 62 and the feed piece 13. In this example, an identical connection is also implemented at the second end face 2a. Of course, one end face 2, 2a could also be designed integrally with an inlet 7 and one side as separate components, whereby it proves advantageous if the housing is designed as a monolithic housing 5 with at least one end face 2, 2a and the porous structure 60.

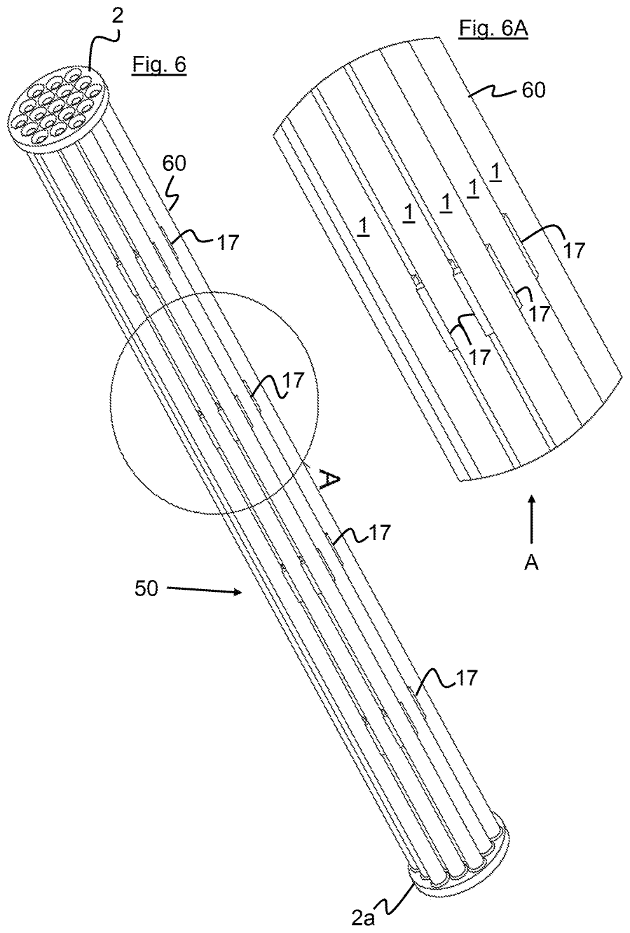

With reference to FIG. 6, a further embodiment is shown in perspective view, wherein the monolithic component 50 is characterized in that it has support structures 17 in order to achieve mechanical reinforcement of the monolithic component 50. Particularly in the case of brittle membrane materials, such as ceramics, the connection of the individual membrane tubes 1 to one another and thus the sensitivity to impacts with the risk of membrane rupture can be significantly improved.

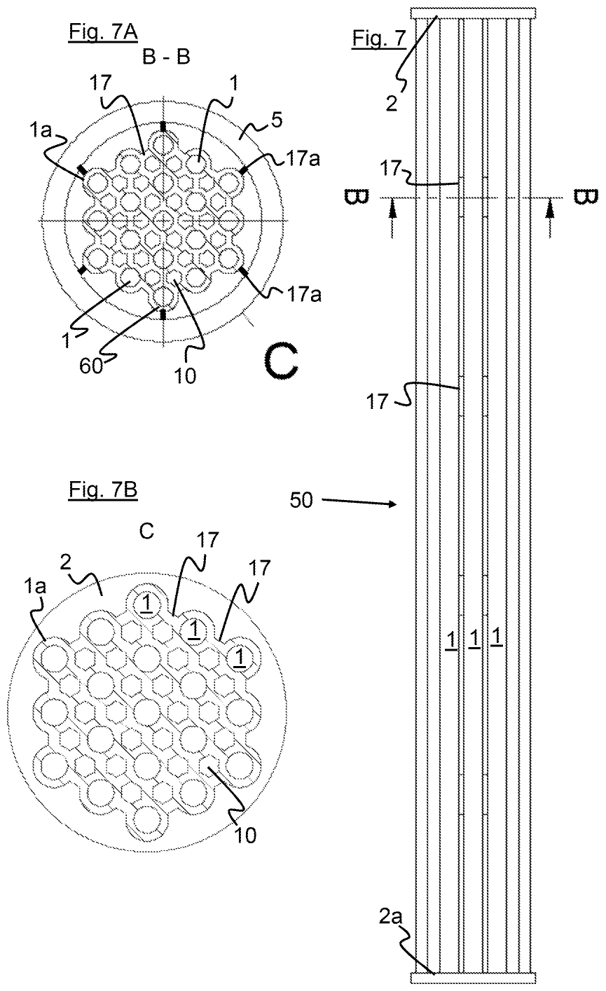

FIG. 6a shows the detail marked “A”, with rods 17 being shown which represent a suitable connection to bring about the aforementioned mechanical stability improvement. Such rods 17 or a support structure 17 can also be continued up to the enclosure 5, cf. for example FIG. 7a.

FIG. 7 shows another illustration of a monolithic component 50 with support structure 17 in a side view, with the enclosure 5 omitted for better visibility.

FIG. 7a shows the sectional plane B-B of FIG. 7, wherein the housing 5 is shown. The support structure 17 extends between the individual membrane tubes 1, wherein 19 membrane tubes 1 being shown in this embodiment, which together form the porous structure 60 or filter element. The support structure 17 is also connected to the housing 5 by enclosure rods 17a to further improve the mechanical stability, for example of the pore-size structure 60.

FIG. 7b shows a further detail of an embodiment of the monolithic component 50 with support structure 17 in sectional view. The 17 membrane tubes 1 shown in this illustration, which together form the membrane filter 60a, are each connected to one another with the adjacent membrane tube 1 by means of the support structure 17.

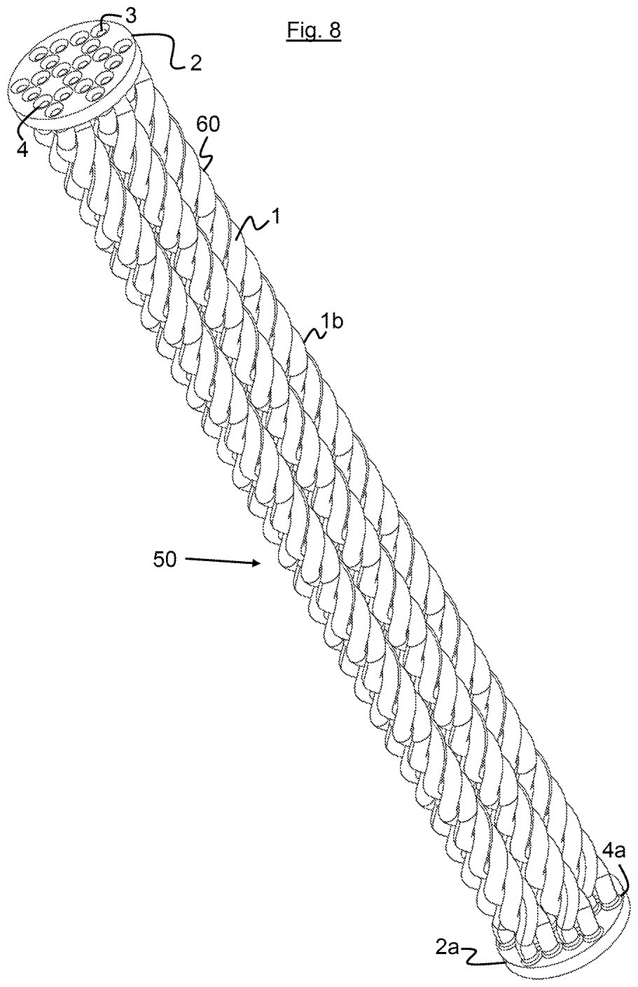

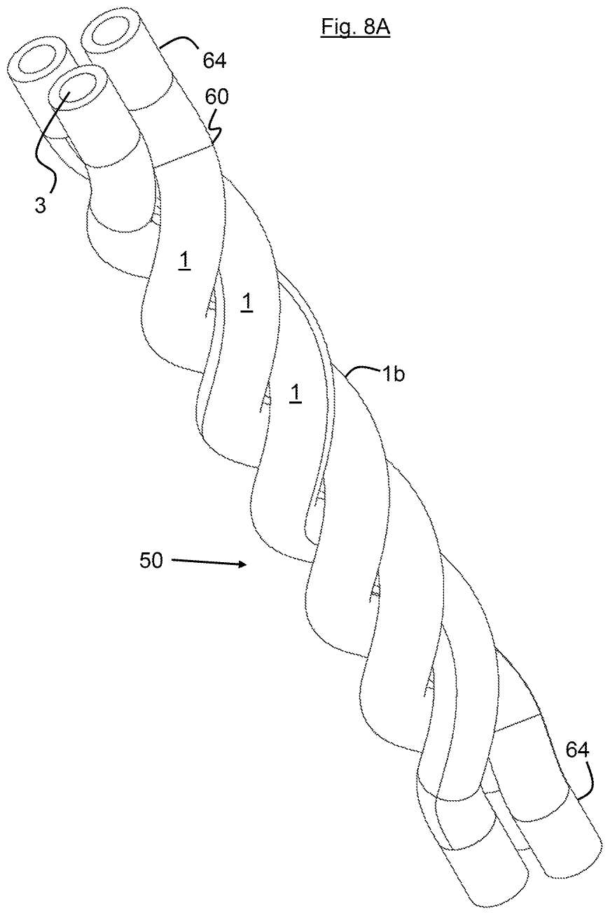

Referring to FIG. 8, another embodiment of a monolithic component is shown, wherein the porous structure comprises curved membrane tubes 1. In this embodiment, the membrane tubes are helically shaped, specifically divided into triple helixes 1b. Helically shaped membrane tubes 1 offer the advantage of better substance transfer on the inside when carrier fluid flows through them. In advantage over straight membrane tubes 1, helically shaped membrane tubes 1 exhibit elastic compliance when subjected to loads in the direction of the main axis of the membrane tube bundle or triple helix 1b. Such loading may occur during operation when the temperature of the fluid flowing through the tube changes rapidly. The membrane tube bundle 1a wants to expand according to the temperature, for example, but is prevented from doing so by the still cold enclosure 5 (cf. e.g., FIG. 3). The same applies to rapid temperature decreases. The triple helix 1b or the helical shape in general acts like a helical spring in this case.

The shape of the membrane tubes shown thus provides a stress-tolerant design that tolerates longitudinal stresses that build up by storing them in a spring-like manner in the triple helix 1b and relaxing them again after the monolithic component 50 has cooled down. Accordingly, this is a stress-tolerant monolithic component 50, for example stress-tolerant regarding longitudinal stress, which can absorb higher stresses, in particular longitudinal stresses caused by temperature differences, before fatigue or even rupture of one or more membrane tubes 1 occurs. Furthermore, the helical structure 1b can also be provided in a stress tolerant manner regarding transverse stress, in which case the membrane tubes 1 have a higher capacity to absorb transverse stresses before fatigue or rupture occurs. This increases the service life and durability of the monolithic components 50, and further simplifies manageability. The membrane filter 60 of this embodiment is constructed of seven triple helixes 1b and thus 21 membrane tubes 1. The membrane tubes open in one piece on their first side into the first end face 2 and on their second side into the second end face 2a. They have the previously described curves 4, 4a to improve mechanical stability and flow guidance for the carrier fluid.

FIG. 8a shows a membrane tube bundle segment consisting of three helically shaped membrane tubes, which together form the triple helix 1b. In this embodiment, the membrane tubes 1 are designed in such a way that they have an impermeable structure 64 at their front ends and wherein the porous structure 60 is arranged in the central part, which is designed for substance transfer with the shell fluid.

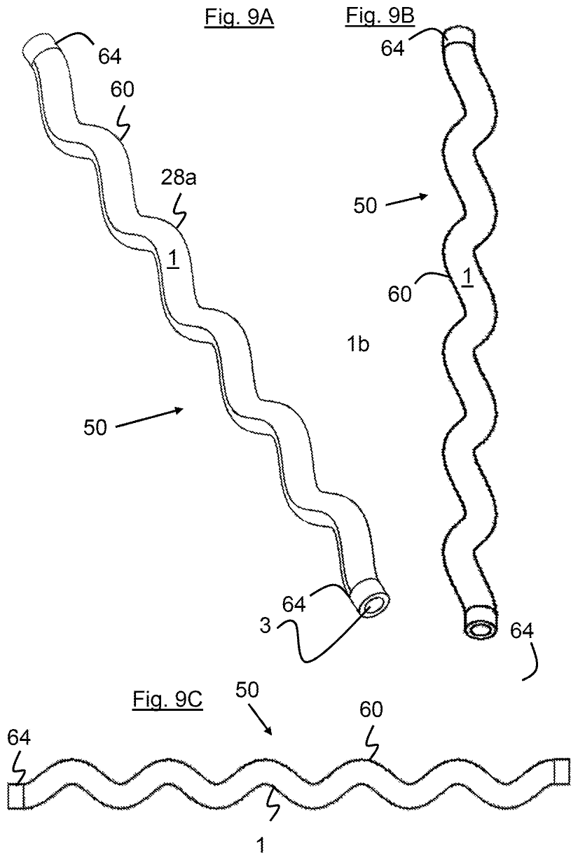

Referring to FIGS. 9a, 9b and 9c, another embodiment of a diaphragm tube 28a is shown which is shaped in a meandering or wavy line manner. In this embodiment, the monolithic component 50 is shaped to improve various requirements. For example, the undulating membrane tube 28a can, if necessary, cause mixing of the carrier fluids flowing inside the tube 28a, so that overall substance transfer towards the shell flow is also improved. In other words, the embodiment shown in FIGS. 9a, 9b, 9c creates a directionally variable flow direction that can induce vortex formation in the carrier fluid. The meandering or undulating membrane tube 28a can be provided such that the bends of the membrane tube 28a alternate with the bends of an adjacent membrane tube 28a, so that overall there is no increased space requirement despite the undulating design of the membrane tube 28a.

Moreover, wave-shaped membrane tubes 28a exhibit the same advantages as the previously described helical membrane tube bundle 1b, namely in terms of mechanical damping effect or elastic compliance in the direction of the main extension axis of the membrane tube 28a In other words, this embodiment is also a suitable stress-tolerant design of the monolithic component 50. The wave-shaped membrane tube 28a is shown in a perspective three-dimensional view in FIG. 9a, in a perspective side view in FIG. 9b, and with FIG. 9c in a side sectional view through the wave-shaped membrane tube 28a.

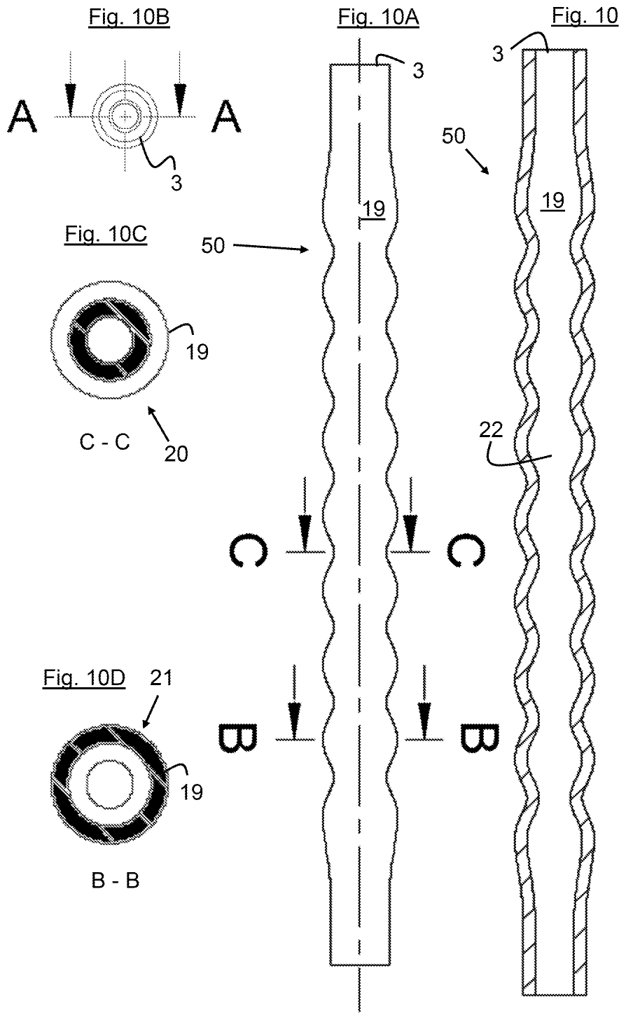

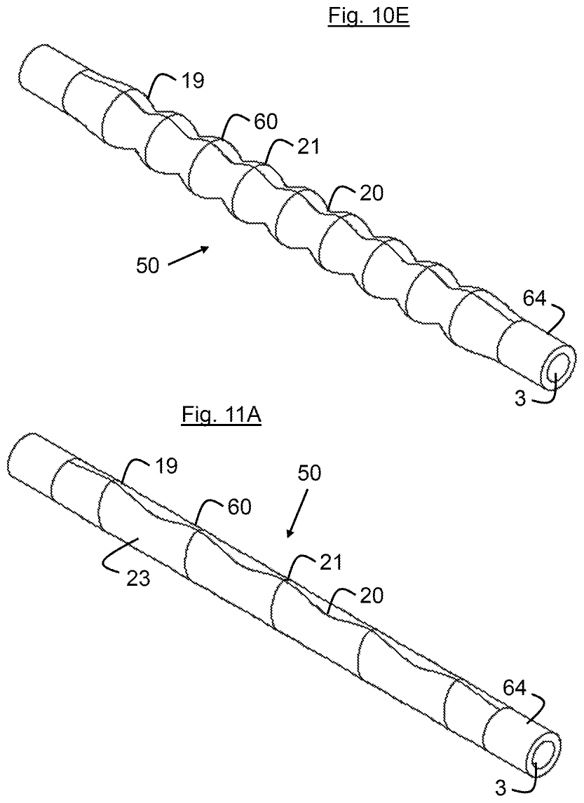

With reference to FIGS. 10 to 11, further possibilities are shown which can be realized with the present invention in a particularly simple and efficient manner, namely the introduction of variable cross-sectional geometries of diaphragm tubes 1. FIG. 10 shows a sectional view through a diaphragm tube 1 with variable cross-sectional geometry. The diaphragm tube cross-section is varied in the direction of flow. Due to the variable cross-sections in the direction of flow, the flow velocities and flow directions also change with the cross-sections, which leads to better mixing of the flowing carrier fluid.

FIG. 10a shows a top view of a correspondingly shaped diaphragm tube 1 with variable cross-section, where the section line B-B shows the widest cross-sectional geometry also shown with FIG. 10d, and the section line C-C shows the narrowest cross-sectional geometry also shown with FIG. 10c.

FIG. 10b shows a top view of an inlet opening 3 of the membrane tube 1, with the plane A-A illustrating the sectional plane of FIG. 10.

Finally, FIG. 10e shows another perspective view of the diaphragm tube 1 with variable cross-sectional geometry. The narrower cross-section 20 alternates with the wider cross-section 21 in an alternating manner. Impermeable material structures 64 are shown at the two ends, and in the central region the membrane tube 1 is designed as a porous structure 60.

FIG. 11a shows a perspective view of a further embodiment of a diaphragm tube with variable cross-sectional geometry 19. Again, the narrowest cross-section 20 alternates with the widest cross-section 21, the ends are formed as an impermeable structure 64, and the porous structure 60 is formed in the central region for material exchange or substance transfer of the carrier fluid with the shell fluid. The diaphragm tube segment has a variable ellipse cross-section, with the long axis of the ellipse cross-sections alternately oriented in the initial position corresponding to the section B-B shown in FIG. 11d and rotated 90° thereto, as shown in FIG. 11e. A longitudinal section along the section line A-A marked in FIG. 11c is shown in FIG. 11. The changes in the flow directions and thus, depending on the fluid, also the mixing can be more pronounced here than in the circular cross sections.

It has been shown that even greater mixing of the carrier fluid flowing through can also be achieved by suitable turbulators 29. Installations such as static mixers as turbulators 29 are indeed known in process engineering as such to improve the mixing of a flowing fluid. However, this does not work easily in membrane tubes, at least not permanently. Static mixers cannot be fixed well in conventional diaphragm tubes, or can be fixed at all with third materials, and therefore regularly perform relative movements to the diaphragm surface during operation. The membrane surface is permanently damaged by the resulting friction and it can no longer fulfill its purpose of separation.

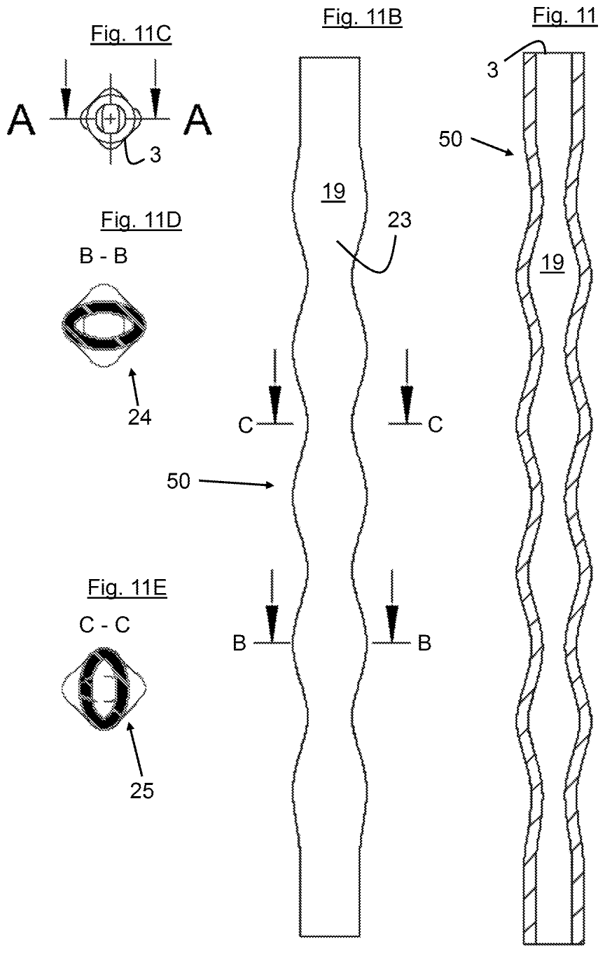

Due to the advantageous process, in which the component is constructed monolithically, it is now possible to form turbulators 29 in one piece with the porous structure 60, so that the described problem of relative movement no longer arises. The individual segments 29a of the turbulators or static mixers are thus an integral component of the porous structure 60, i.e., of the tubular membrane 1, 19, 28. The monolithic composite of turbulators 29 with porous structure 60 as an integrated component eliminates the problem of relative movements, so that membrane damage at this point is reduced or even eliminated and thus permanent operation is reliably ensured. FIG. 12b shows the embodiment of FIG. 12a in perspective view.

FIG. 12c shows a diaphragm tube 28 with a plurality of turbulators 29 arranged next to each other or one after the other, which are each arranged at an angle to each other, for example each offset by 90° to each other, and thus ensure much greater mixing of the carrier fluid and thus a better substance transfer with the shell fluid. FIG. 12d shows a top view of an inlet 3 of the porous structure 60 in the form of the membrane tube 28, with the line A-A illustrating the sectional plane of FIG. 12c. Finally, FIG. 12e shows another perspective view of the membrane tube 28. The aforementioned or other turbulators 29 can also be monolithically inserted in the other embodiments, for example in the helical membrane tube bundles 1a, 1b, or in the wave-shaped or meandering membrane tubes 28a for intensifying the mixing of the carrier fluid flowing through the membrane tube 1, 28, 28a.

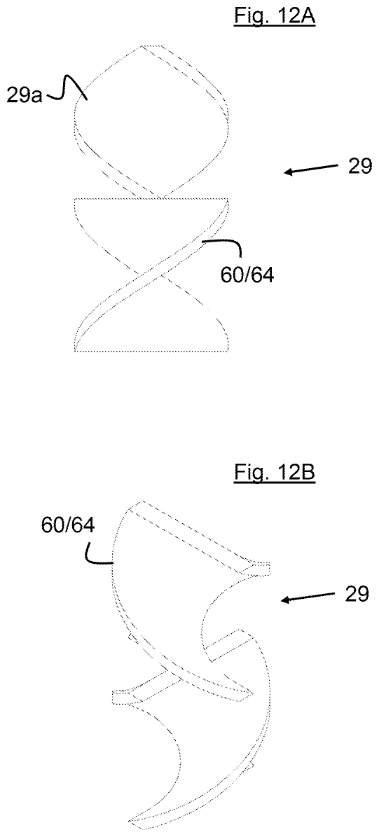

With reference to FIG. 13, a further embodiment of the monolithic component 50 is shown, wherein the membrane tubes 1 have an additional layer 30 on the side surfaces 9, which is either applied monolithically and thus consists of compatible or identical material to the porous structure 60, or which is applied as a coating 30 after the porous structure has been manufactured. This can be one or more layers 30 on the inner side 9, which have a differing porosity and/or pore-wide distribution.

This is shown enlarged in FIG. 13a, where the coating 30 is applied to the inner surfaces 9 of the membrane tubes 1. The coating 30 is also extended to the surface of the end plate 2 to further enhance the transition from the membrane tube 1 through the inlet 3 to the end plate 2. The coating can be produced during the additive manufacturing process as a separate track in the layered structure of the filter body.

These tracks for producing the coating 30 can be laid by a separate print head which deposits, for example, an inorganic mass, for example an unfilled or ceramic- or metal-filled polymeric mass which results in a finer pore structure than in the base body. One or more coatings can also be applied subsequently after firing of the base body and sintered, for example, at a lower temperature, for example in the case of using inorganically filled polymeric masses. In one example, a ceramic coating can be applied to a metallic base body.

Finally, FIG. 13b shows a top view of face 2, with line A-A representing the section plane of FIG. 13.

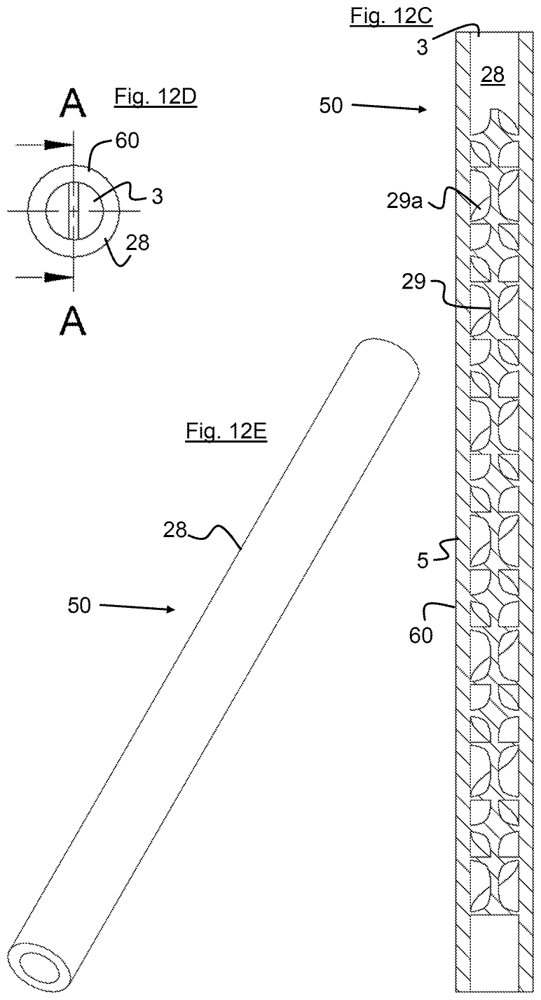

Referring to FIG. 14, an exemplary pile 31 of porous structure 60 obtainable by the method of the present invention is shown. The pile structure 31 has a plurality of pores 32. The resulting pore structure, as shown in FIG. 14, can be produced, for example, with additive manufacturing using the principle of thermal phase separation.

In principle, this process involves dissolving at least one polymer in a solvent that is poorly soluble at room temperature at an elevated temperature. The composition of the solution is selected—if necessary by adding further additives—so that phase separation takes place during cooling and the polymer solution separates into a polymer-rich phase (membrane matrix) and a polymer-poor phase (pores). The membrane is shaped by continuous extrusion through a ring gap nozzle in the case of tubular membranes or also through a slot nozzle for flat membranes. The dimensions of the membrane that can be obtained depend on the geometry of the nozzle, and can only be varied within narrow limits. Afterwards, the membranes are freed from the auxiliary materials by extraction, then dried and, in further steps, joined with various components to form a filter.

In a novel process, the aforementioned solution is formed into a membrane using an extrusion printer. In this process, the TiPS solution or base material is fed to the printer nozzle above the segregation temperature and deposited in the form of thin filaments into a desired shape, such as a tubular membrane 1. Phase separation occurs as the TiPS solution cools. The phase separation can be further influenced by providing a non-solvent, such as in particular water vapor or glycerol (N-TiPs).

Sandwich structures with different pore structures can also be built by depositing TiPS solutions with different compositions.

In addition, a polymer melt can be extruded at the same pressure to form a non-permeable layer upon cooling. This polymer can be printed to form impermeable housing parts of the filter, such as a filtrate collection tube or filtrate discharge tube, an aeration unit, or even filter heads with connections.

As an alternative to two-head printing, nozzles with a mixing function for two or more components can also be used. In this case, it is possible to change the composition during the printing process and thus produce areas of different porosity up to impermeable areas with only one head. This is therefore a mixing head.

A pore structure resulting from such a process is shown in FIG. 14, where the pore structure is essentially determined by the composition of the polymer solution of the base material 70, 71, 72, 73, 74. A phase inversion results in a solid matrix 31 of polymer material with, if applicable, ceramic particles enclosed therein. According to the volume fraction of the solvent, cavities 32 are formed, which are typically interconnected. The size and number of the cavities depends on the composition of the polymer solution (polymer portion possibly with ceramic portion or metal portion, solvent portion and/or additives) and the precipitation conditions or the ambient conditions (temperature, medium, etc.).

The resulting microporous structure 60 is basically suitable as a filter medium for micro- and ultrafiltration. Defined particles cannot be detected in the solid matrix. The solvent can be removed from the finished filter in a separate step or even when the filter is put into operation, thus protecting the filter during transport and installation for a long time, depending on the composition of the solvent. It also reduces clogging of the filter with foreign matter, such as dust.

Generally, additive manufacturing processes, such as 3D printing, are preferred for the structures of porous structures 60 described herein to produce material systems with intrinsically porous portions. For example, an extrusion process can be used.

For the membrane filters 60a according to the invention, it is typically the case that the resulting pore structure of the porous material 60 is not to be specified as a predetermined pattern in a control program and thus the production head does not have to generate the specific pore structure at the micrometer level. Rather, the pore structure of the porous material 60 can be generated by the composition of the formulation used, for example, in the extraction process, optionally with subsequent steps to solidify the base material 70, 71, 72, 73, 74, such as sintering of inorganic, e.g., ceramic, green bodies.

Melt extrusion of polymer pastes generally results in dense, non-porous structures. The use of formulations in which inorganic or organic fillers or additives for pore formation are added to the pastes provides further options. With a suitable composition, the desired microporous structures are formed when the deposited “beads” are cooled. This structural change, also known as phase inversion, can be controlled by suitable ambient conditions in the installation space for building up the component 50. For example, the process of phase inversion or crosslinking can be influenced by the atmosphere in the build space (temperature/humidity) or UV irradiation.

In the example of the Multijet Fusion process, for example, a powder bed is used. Sintering is triggered via infrared sources. Using suitable inks, different light absorption rates can be realized in this process depending on the location, resulting in differently dense areas. Additives can be added to these inks, for example polymer nanoparticles, which are embedded during the sintering process and represent additional scope for designing location-dependent pore structures. In other words, in this method, a location-independent radiation source or energy source can be used for thermal post-treatment of the base material 70, 71, 72, 73, 74, whereby the location-dependent adjustment of the porosity of the base material 70, 71, 72, 73, 74 is realized by means of the supply of suitable inks.

In selective laser sintering (SLS) of polymer powders, infiltration is required, depending on the polymer, to produce truly nonporous components. With suitable polymers, e.g., polypropylene, the body can be made porous or impermeable by adjusting the sintering parameters. The degree of porosity can also be adjusted. By adjusting the sintering parameters depending on the location, which may be possible by suitable software adjustments, porous and impermeable areas can be produced in a component 50. For example, non-porous housings 5 and end plates 2, 2a on the one hand and porous structures 60, such as membrane tubes 1, can be monolithically joined in this way. In the area of the membrane filter 60a, even areas of different porosity can be realized. Membranes 60a with a porosity gradient in the direction of the membrane surface or layers of different porosity can be produced. This variation is caused here only by the sintering parameters.

For inorganic materials such as ceramic or metallic materials, 3D extrusion can be used as a manufacturing process to produce so-called green bodies or precursors for subsequent sintering in a sintering furnace. Another advantage compared to extruded inorganic filter elements is the possibility to make a smaller wall thickness. This results in shorter times in the sintering furnace due to the lower heat storage, which has an advantageous effect on the manufacturing costs.

Different porosities can be created by different formulations of the inorganic masses. The prerequisite is a multi-head device with an extrusion head for each desired porosity, by means of which the corresponding inorganic paste, e.g., metallic or ceramic paste, is deposited at the intended location. In other words, the setting of the porosity in this example is realized by the respective head of the device depositing a respective base material 70, 71, 72, 73, 74 and monolithically bonding it to the rest of the component 50.

Referring now to FIG. 15, a further formation of a heap 31a is shown with pores 32a. Such a configuration of the heap 31a can be achieved, for example, by means of the production of polymeric membranes in a sintering process, in which polymeric particles are sintered together by the action of heat. In this process, the sintering conditions are adjusted so that the polymer particles combine but still retain their particle shape to a certain extent. Thus, the resulting pore structure is essentially determined by the polymer particles, for example by their shape and size. The polymer particles are thereby bonded together by the sintering process, with cavities 32a being formed between the polymer particles, which are typically bonded together and form a coherent cavity 32a. The size of the cavities is thereby dependent on the size of the polymer particles. The microporous structure thus formed is basically suitable as a filter medium for microfiltration and ultrafiltration. The pore size desired in each case can be adjusted by suitable selection of the particle size, with the particles being larger than the pores.

Referring to FIG. 16, a pile 31b is shown which is still obtainable by a further manufacturing method, wherein the pile comprises inorganic particles, for example metallic or ceramic particles, which form cavities 32b between the particles. For example, to manufacture inorganic membranes 60a, a green body (precursor) can first be prepared from an inorganic paste. For example, the paste consists essentially of ceramic or metallic particles, organic binders and additives. After drying or solidification of the paste, the green body is obtained, which is formed into a microporous inorganic body 60 in a subsequent firing step, depending on the composition of the paste. The resulting pore structure, as shown in FIG. 16, is mainly determined by the inorganic particles. The inorganic particles of the pile 31b, e.g., ceramic particles and/or metal particles, are bonded together by the sintering process, but retain their particle shape to a certain extent. Cavities 32b exist between the inorganic particles, which are advantageously connected to each other to form a common cavity. The size of the cavities depends on the size and shape of the inorganic particles. The organic components of the base material 70, 71, 72, 73, 74 decompose at the high firing temperatures. The microporous structure thus formed is basically suitable as a filter medium for microfiltration and ultrafiltration. The pore size desired in each case can be set by suitable selection of the particle size, with the particles being larger than the pores.

The microporous structure thus formed, possibly with a high inorganic content, e.g., in the form of ceramic particles and/or metal particles, represents the green body for the subsequent firing process, for example as part of a manufacturing process according to or analogous to the TiPS process. The microporous structure 60 changes only slightly as a result of the firing process and is basically suitable as a filter medium for microfiltration and ultrafiltration. Defined particles cannot be detected in the solid matrix, or possibly detectable inorganic particles of the heap 31, 31a, 31b are smaller than the pores formed.

A sintering or baking of the green bodies can be carried out at 1600° C. or more, for example. A filling ratio of the inorganic particles in the pile 31, 31a, 31b in the polymeric phase can be between 50 to 70%. At such mixing ratios, it is advantageous to use dynamic mixers.

Alternatively, the resulting microporous structure 60 without inorganic fillers, e.g., without ceramic or metallic fillers, can be used without further firing. In this case, it is advantageous to remove the leachable components to complete the filter.

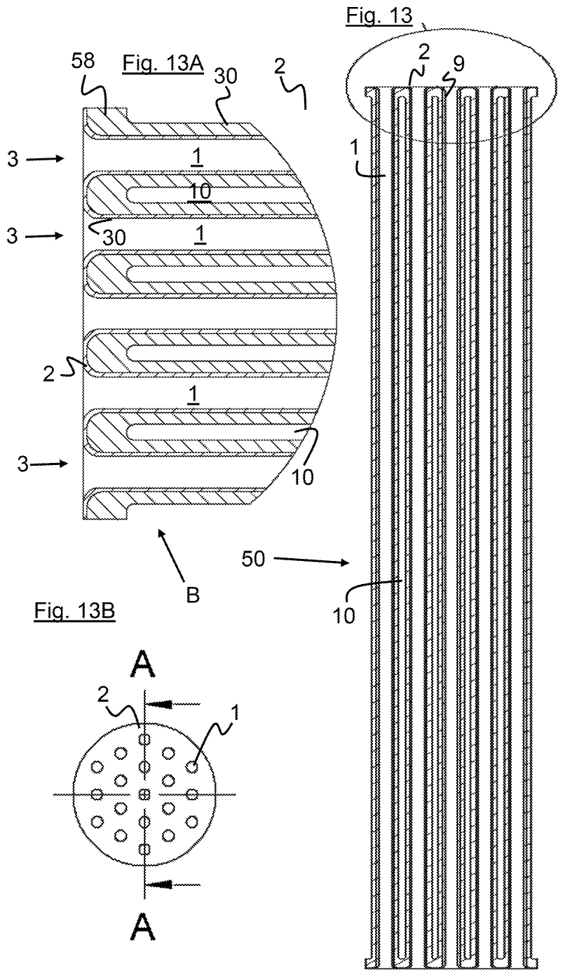

With reference to FIG. 17, the sequence of the process for manufacturing a component 50 is shown in schematic diagrammatic representation. In the providing step 100, the porous or porosable base material 70, 71, 72, 73, 74 is provided. Base material 70, 71, 72, 73, 74 can be provided, for example, in a non-exhaustive manner, as powdered base material 71, as liquid base material 72, as solid base material 73 or as pasty base material 74. The base material 70, 71, 72, 73, 74 is thereby intrinsically porous adjusted, adjustable or prepared. The base material 70, 71, 72, 73, 74 can thereby be provided in various ways. For example, providing 100 the base material 70, 71, 72, 73, 74 comprises stocking 102 an extruder device with base material 70, 71, 72, 73, 74. The step of providing 100 may also comprise placing or preparing 104 powdered base material 71, for example by means of a depositing device 80. The step of providing 100 may also comprise mixing 106 the base material 70, 71, 72, 73, 74 or heating 108 the base material 70, 71, 72, 73, 74. Thus, providing 100 comprises possibly preparing the base material 70, 71, 72, 73, 74, for example at a specific point, further for example a point of a point matrix of the monolithic component 50 to be manufactured, for a subsequent material application. Thus, providing 100 may also comprise approaching the point to be approached by means of the application device, if the application device has to be moved and/or adjusted accordingly for this purpose. The step of providing 100 may also comprise preparing a radiation source for subsequent activation or heating of the point to be approached.

After preparation, the setting 110 of the porosity of the porous or porosable base material 70, 71, 72, 73, 74 for the material application to be carried out is carried out. The adjustment can also be carried out in various ways. For example, admixing 112 of additive or filler to the base material 70, 71, 72, 73, 74 to adjust the porosity at the moment of material application may be included. Further, adjusting curing parameters 114 may be included to adjust the porous or porosable base material 70, 71, 72, 73, 74 with respect to porosity at step 110.

The step of adjusting 110 may also comprise selecting 116 a source material 70, 71, 72, 73, 74 to be applied from a plurality of at least two source materials 70, 71, 72, 73, 74. The selection may also result in a mix if the base material 70, 71, 72, 73, 74 comprises two base materials 70, 71, 72, 73, 74 that may be fed simultaneously or alternately to produce a mix of materials at the point of the point-target matrix to be approached.

A location-dependent radiation intensity can be provided according to step 118, thereby adjusting the porosity of the base material 70, 71, 72, 73, 74 in step 110. Thus, with step 118, based on the point of the point-target matrix selected or to be approached, a radiation intensity stored, for example, in a table can be retrieved and supplied to the radiation source for output.

The step of adjusting 110 may also include adjusting 119 the light absorbance of the base material 70, 71, 72, 73, 74 in a location-dependent manner. This may be the location-dependent supply of ink when, for example, the component build-up is performed using a location-independent radiation source. The objective of the adjustment step 110 is that the porous or porosable base material 70, 71, 72, 73, 74 is designed or prepared during the material application in such a way that it can form a coherent porous material structure in the component, which can preferably be variably adjusted in terms of porosity at the respective point of the point-target matrix to be approached, in order to build up a porous material structure 60 on the one hand, but also impermeable regions 64 monolithically formed therewith. Ideally, this can be carried out in a common process sequence in such a way that the monolithic component 50 is produced continuously in one piece, preferably without interruption. Depending on the process used, this can also be done in steps, with appropriate pauses between steps, should this be necessary for the process. Finally, the manufactured monolithic component 50 is characterized by the fact that there is a material-locking connection between all components of the monolithic component 50 in such a way that the component appears to be grown from one piece, so that the areas that are prepared for a flow passage are already formed during construction or the manufacture of the monolithic component 50 are produced in such a way that these areas allow the flow of current; on the other hand, that the impermeable areas, which are precisely intended to prevent a flow of current, as well as the enclosure, are already set to be correspondingly impermeable during the manufacture of the monolithic component. Particularly preferably, the entire monolithic component 50 consists of mutually compatible material or of the same base material 70, 71, 72, 73, 74, to which various filler materials or additives may be added.

The adjusted base material 70, 71, 72, 73, 74 is applied at the point to be approached in step 120. The application can have different characteristics. Depending on the monolithic component 50 to be produced, this can be the dispensing of set base material 70, 71, 72, 73, 74 by means of an application machine according to step 122. Such an application machine is, for example, an extruder. It may also comprise a supplementary depositing of powdered base material 71 according to step 124 at the point to be approached, if this is not completely feasible with step 104. Applying 126, for example manually applying a paste, may also be included in the applying 120 step. The application 120 results in base material 70, 71, 72, 73, 74 being applied to the monolithic component 50 in such a way that areas with impermeable material structure on the one hand and areas with porous material structure on the other hand are formed, the areas with porous material structure also being further subdivisible into areas with different porosity.

Finally, in step 130, applying 120, adjusting 110 and, if necessary, sub-steps therefrom are continued until the monolithic component 50 is finally completed. Depending on the selected underlying process, steps 110, 120 are carried out repetitively, for example for each point of the point-target matrix, or for each layer of the layer-target matrix, or the base material 70, 71, 72, 73, 74 is first adjusted in step 110, for example for contiguous areas of the monolithic component, and then approached or applied in the entire step 120.

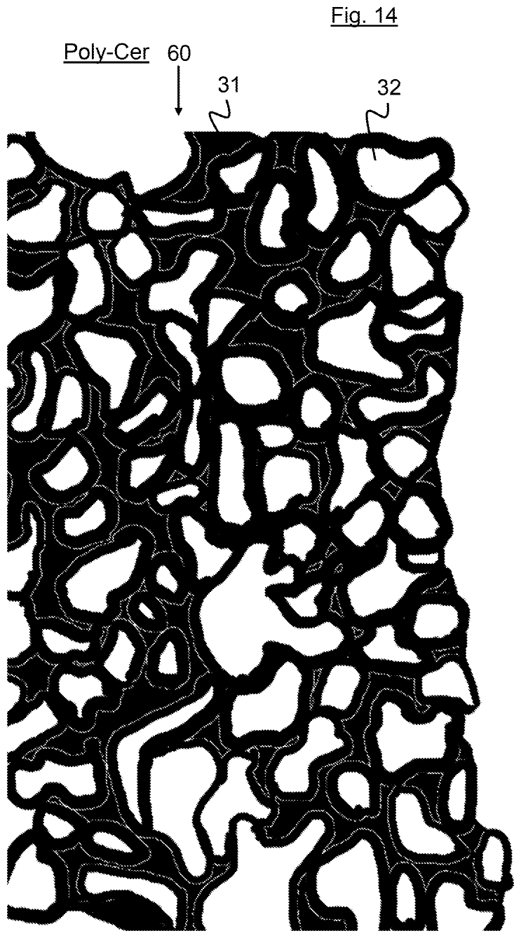

FIGS. 18 to 32 show examples of how some of the process steps described above can be carried out. FIG. 18 shows the application 104 of powdered base material 71 to a partially completed monolithic component 50 by means of a depositing device 80. The base material 70 is deposited in step 104 such that, for example, the powdered base material 71 is deposited in a matrix plane 90 in a deposition region 92, whereas no base material 71 is deposited in a region 94.

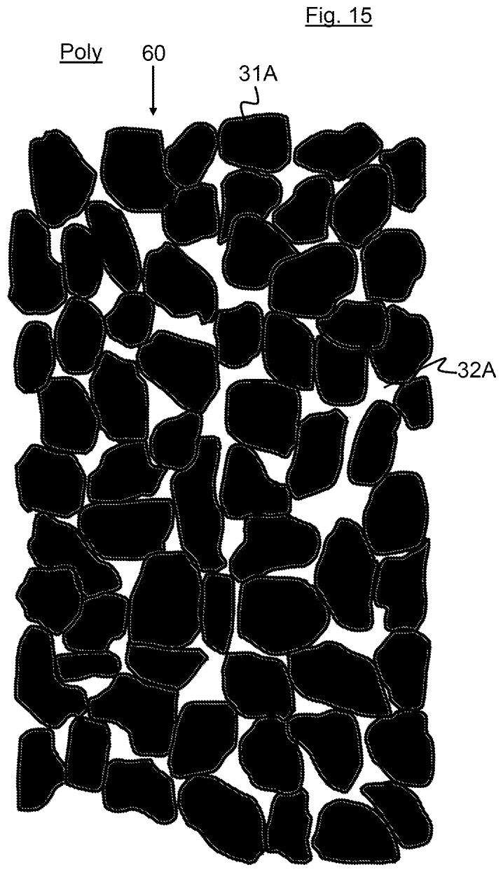

FIG. 19 shows an example of heating 108 of solid base material 73 in a heating furnace 81 using heat 81a.

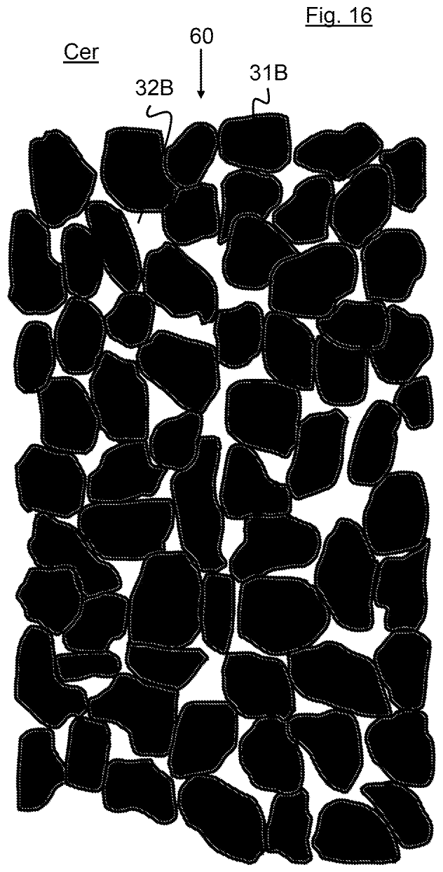

FIG. 20 shows an example of mixing 112 of base material 70 with additive 75 and/or filler 76 in a mixing device 82. Base material 70 is fed to the mixing vessel 82c in a feed quantity adjustable by means of the quantity regulator 82a; additive 75 and/or filler 76 is also fed to the mixing vessel 82c in a feed quantity separately adjustable by means of the quantity regulator 82b. Possibly, at least one of the quantity controllers 82a, 82b may also be dispensable, depending on the process conditions. The mixing device 82 can also have three feed containers if additive 75 or filler 76 is to be supplied separately. The illustration of FIG. 20 does not differ in the principle form shown if either additive 75 or filler 76 or both are to be mixed together with the base material 70, so that these variants are combined in one FIG. 20 for the sake of brevity.

The quantity regulator(s) 82a, 82b allow(s) the adjustment 110 of the subsequent porosity of the base material 70 and thus of areas of the monolithic component 50 to be produced. The mixed base material 70a is circulated in the mixing container 82c, for example when liquid base material 72 is used. The mixing container 82c has a starting quantity regulator 82e in the outlet, by means of which the quantity to be applied for the application 120 can be adjusted. For example, FIG. 20 shows for this purpose a punctiform application 120 of the base material 70a to the outlined monolithic component 50, the punctiform application 120 being achievable, for example, by means of opening and closing the output quantity regulator 82e.

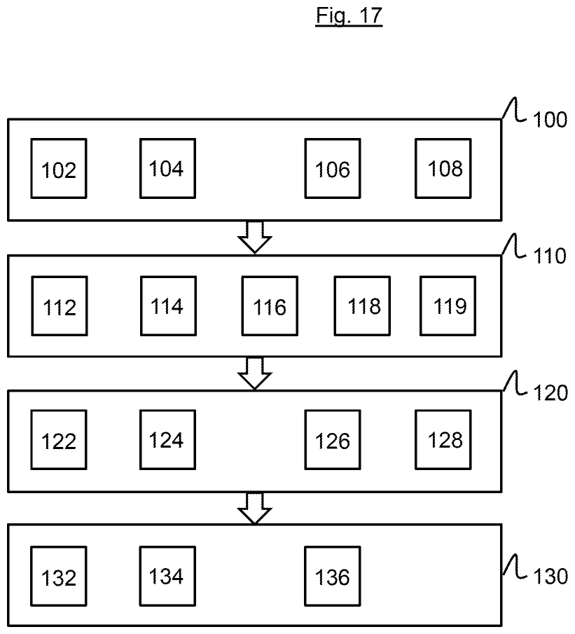

FIG. 21 shows a further embodiment of a depositing device or application machine 80 for applying base material 70 to a component carrier 80b or, if the monolithic component 50 has already been partially applied to the component carrier 80b, to the partially finished monolithic component 50. By means of a feed 80a, for example, a coolant, or also a precipitant or a hardener can be supplied during application 110 and thus curing parameters 114 can be set.

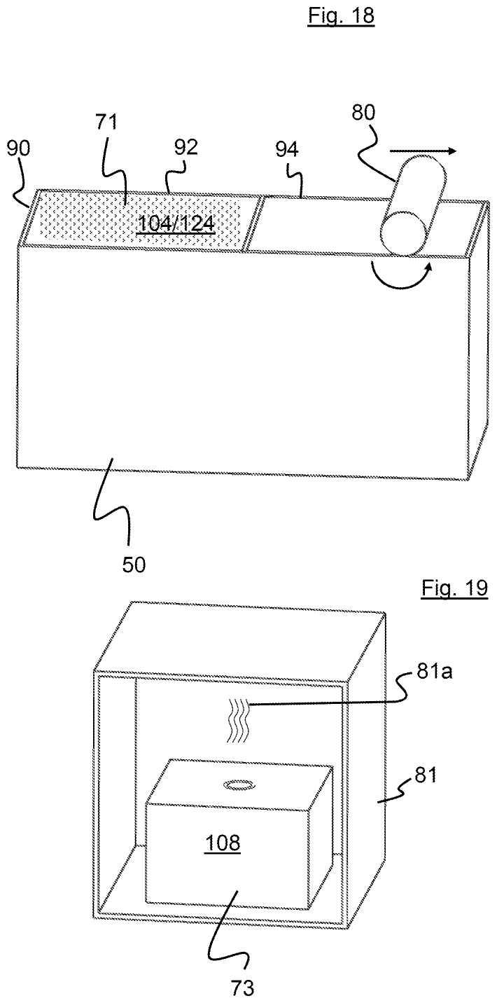

Still another alternative for setting the porous or porosable base material 70 is shown in FIG. 22 with the provision of two depositing devices 80, 80′. Thus, according to step 116, an already preset base material 70, 71, 72, 73, 74 can be selected by performing the material application 110 on the component support 80b or the partially applied monolithic component 50 with the corresponding deposition device 80, 80′.

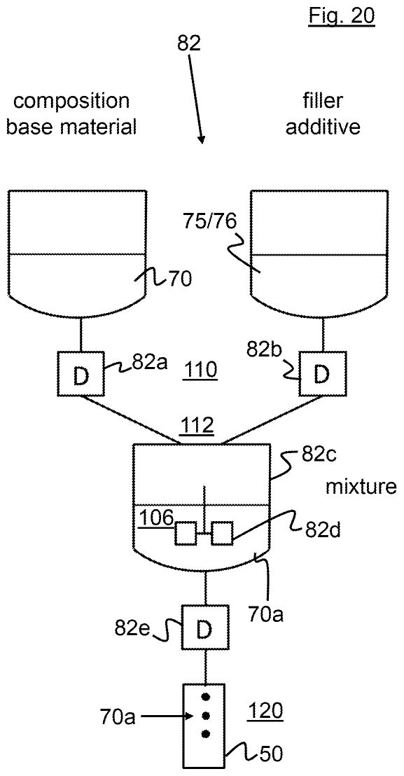

FIG. 23 illustrates an example of providing 118 a location-dependent radiation intensity for transferring the base material 70 into material bonded to the monolithic component 50. For example, an excitation or activation arrangement 83 includes a radiation source 83a and a deflection or directing device 83b to direct radiation 83c to the target point 50a of the point matrix on the monolithic component 50 or the component support 80b.

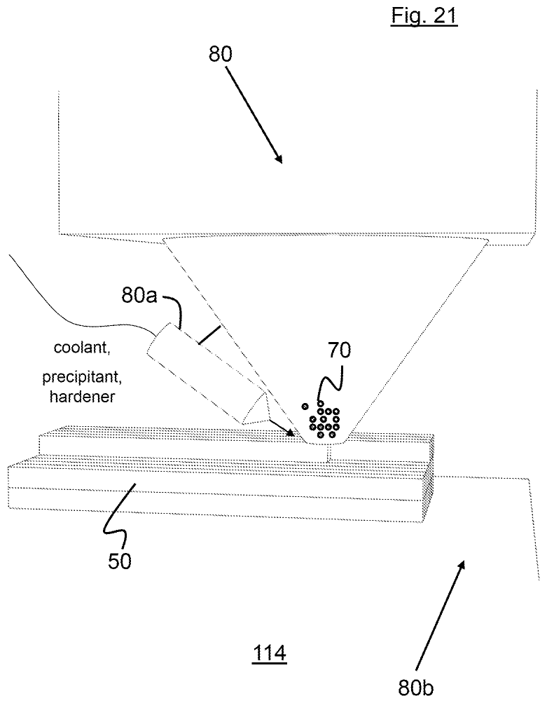

Referring to FIG. 24, the location-dependent adjustment 119 of the light absorption capability of the base material 70, 71, 72, 73, 74 is by means of a mobile or movable activation device 84. The activation device 84 comprises one or more spray heads 84b. For example, an absorption modifier 77, such as an ink, can be applied to the prepared base material 70 by means of the spray head or heads 84b, not at every point of the component 50 to be produced, but selectively, so that the porosity of the component 50 can be adjusted differently at the points 50a where the absorption modifier 77 is applied than at the points 50a where no absorption modifier 77 is applied. Thus, the light absorption capability of the base material 70, 71, 72, 73, 74 is adjusted in a location-dependent manner by means of (additional) application of the absorption modifier 77 in step 119, so that a location-dependent porosity can be produced in the component 50 during subsequent irradiation, as also shown, for example, with FIG. 23. The activation device 84 may further comprise one or more radiation source(s) 84a for emitting an activation radiation 84c. Areas previously covered with ink 77 are activated differently compared to areas not covered with ink 77. For example, a region of the component 50 to be manufactured to which absorption modifier 77 has been applied may receive more radiant power 84c from the radiation source 84a, thereby fusing more densely and having lower porosity at the point 50a compared to other regions of the component 50 to which absorption modifier 77 has not been applied.

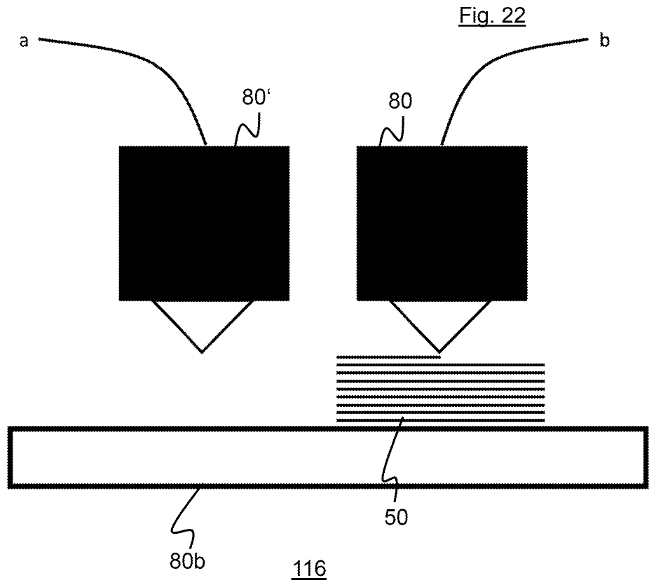

FIG. 25 illustrates the application 122 of base material 70, 71, 72, 73, 74 by means of a depositing device 80 on already partially deposited component 50. The depositing device 80 is designed to be movable horizontally, i.e., in at least two axial directions, so that any point of the component carrier 80b can be approached. A vertical movement, i.e., an up and down movement, is also made possible. Alternatively or cumulatively, the deposit device 80 can be designed to be movable in order to enable movement in all three spatial directions in total, so that each point of the point matrix can be approached with the depositing device 80. A “strand-by-strand” or “bead-by-bead” depositing 122 of base material 70, 71, 72, 73, 74 is shown.

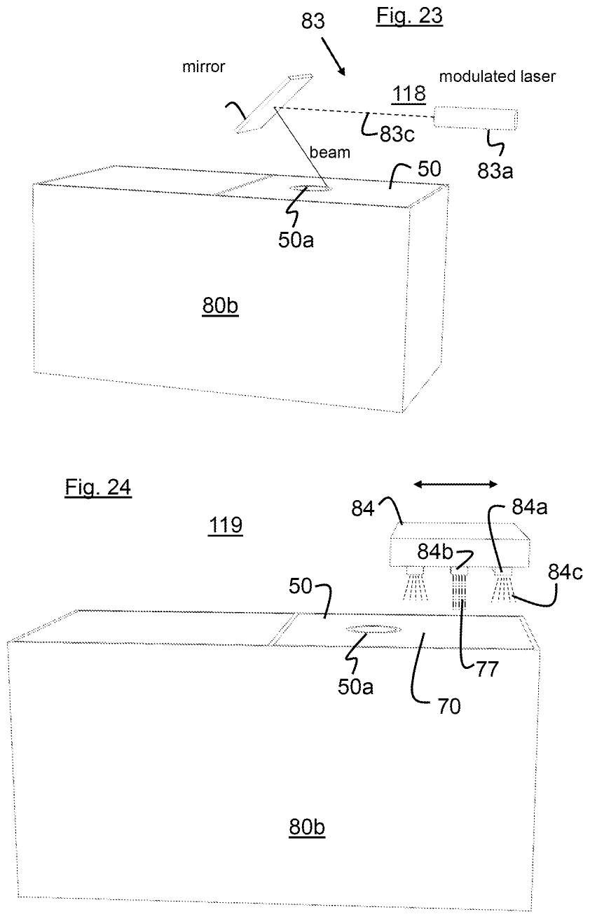

Referring to FIG. 26, the annular or helical application 126 of paste-like base material 74 by means of a depositing device 80 is shown.

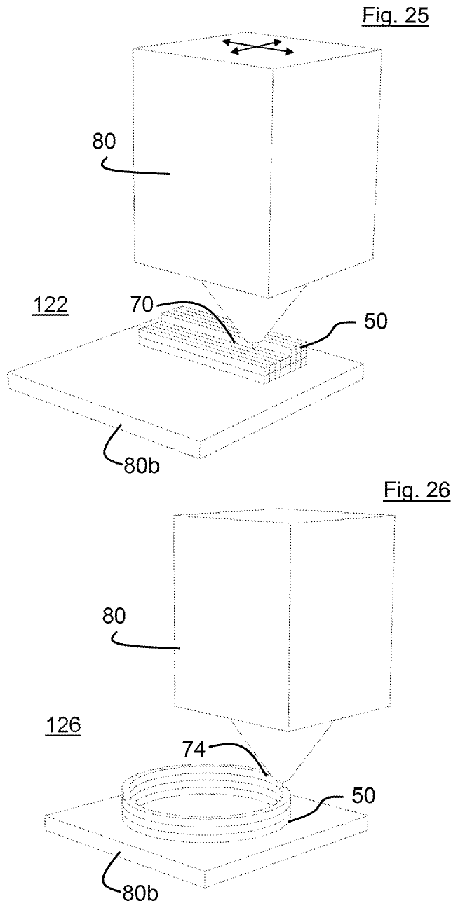

With FIG. 27, the firing 132 of a green body is illustrated in the case where the green body is first built up from base material 70, 71, 72, 73, 74 and is finished as a whole in the firing step 132. In this case, the green body is placed in the heating device 81, for example in a firing chamber, and heated by means of a heat source 81a.

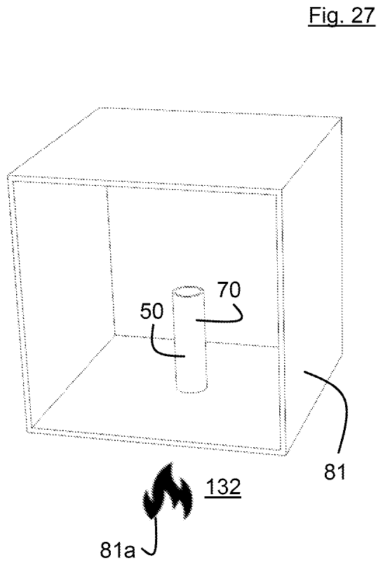

With reference to FIG. 28, a wash-out step 134 is shown, whereby any auxiliary materials required for the application of the base material 70, 71, 72, 73, 74 or for the production of the component 50 are washed out of the component 50 so that they can be removed. For this purpose, the component 50 is placed in a bath 85 with rinsing solution 85a and rinsed.

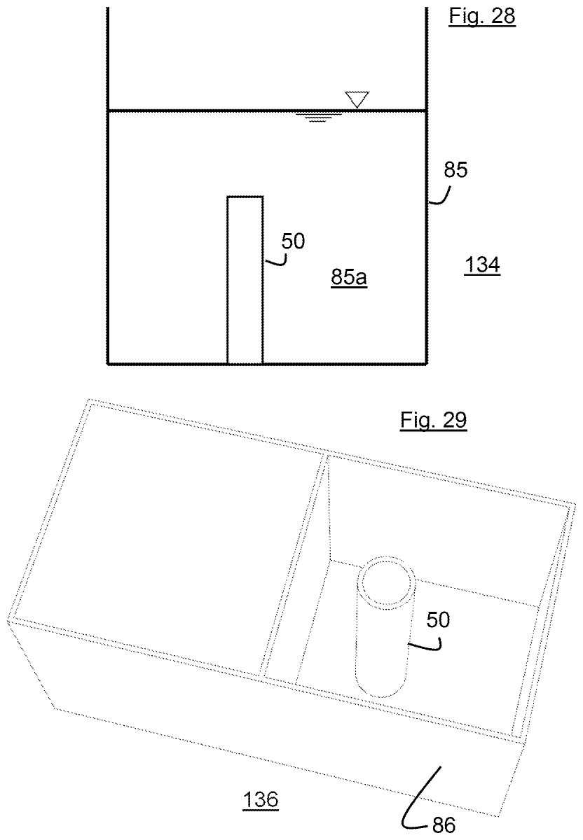

Finally, FIG. 29 shows the removal of any excess powder in step 136 in a flushing chamber 86, for example by means of compressed air.

It is apparent to those skilled in the art that the embodiments described above are to be understood as exemplary and that the invention is not limited to these, but can be varied in a variety of ways without departing from the scope of protection of the claims. Furthermore, it is apparent that the features, whether disclosed in the description, the claims, the figures or otherwise, also individually define essential components of the invention, even if they are described together with other features. In all figures, the same reference signs represent the same objects, so that descriptions of objects which may be mentioned in only one or in any case not with respect to all figures can also be transferred to these figures, with respect to which the object is not explicitly described in the description.

### LIST OF REFERENCE CHARACTERS

1 Carrier side, membrane tube, filter capillary
1a Membrane tube bundle
1b Triple helix
2, 2a End face, end plate
3 Diaphragm inlet
4 Transition or fillet
4a Flow guidance
5 Enclosure, housing
6 Transition
7 Inlet, outlet
8 Enveloping fluid inlet or outlet, filtrate connection
9 Side surface of the diaphragm tube
10 Shell side, filtrate chamber
11 Groove
12 Sealing element
13 Inlet or outlet piece
14 Flat sealing element
15 Clamping ring
16 Overhang
17 rod
17a Housing rod
19 Diaphragm tube with variable cross section
20 narrower cross section
21 Another cross section
22 Longitudinal section
23 Elliptical cross section
24 Initial position
25 90° rotated
26 Longitudinal section
27 Longitudinal section
28 Tubular diaphragm
28a Shaft tube diaphragm
29 Turbulator, static mixer
29a Turbulator flank
30 Coating
31, 31a, 31b Combined pile of the porous structure, typically with inorganic particles or ceramic, metallic or polymeric particles.
32, 32a, 32b Pore in pile
50 monolithic component
50a target point
52 Carrier fluid manifold
54 Carrier fluid chamber
56 shell fluid manifold
58 Connection collar
60 Porous structure
60a Membrane or membrane filter
62 Separate housing
64 Impermeable area
70 Source material
70a mixed base material
71 Base material, powdery
72 Base material, liquid
73 Base material, solid
74 Base material, pasty
75 Additive
76 Filler
77 Absorption modifier, ink
80 Deposition device or application machine
80′ second deposition device
80a Feed
80b Component carrier
81 Heating device
81a Heat generation by means of the heating device 84
82 Mixing device
82a Volume regulator Base material
82b Flow regulator additive/filler
82c Mixing tank
82d Rotary mixer
82e Output quantity controller
83 Excitation or activation arrangement
83a Radiation source
83b Deflection or guiding device
83c Radiation
84 Activation device or ink print head, possibly with radiation source
84a Radiation source
84b Ink print head or spray device
84c Radiation
85 Bath
85a Rinsing solution
86 Chamber
90 Matrix level
92 Deposition area
94 another area
100 Providing step
102 Stocking step
104 Placing step
106 Mixing step
108 Heating up step
110 Adjusting step
112 Mixing step
114 Setting curing parameters
116 Selection of source material
118 Setting the location-dependent radiation intensity
119 Adjusting the position-dependent light absorption capacity, mixing ink
120 step of Applying
122 step of Output or alignment of the application machine
124 step of depositing powdered base material
126 step of (Manual) application of base material
130 step of continuing or ending the manufacturing process
132 step of burning a green body
134 step of washing out auxiliary materials
136 step of removing excess powder

1.-38. (canceled)

39. An additive manufacturing method for producing a component (50) having at least partially or at least locally a porous material structure (60), comprising the steps of:
providing (100, 102, 104, 106, 108) a porous or porosable base material (70, 70a, 71, 72, 73, 74);
applying (120, 122, 124, 126) the porous or porosable base material to build up the component; and
adjusting (110, 112, 114, 116, 118, 119) a porosity of the porous or porosable base material during the applying.

40. The additive manufacturing method according to claim 39, wherein the step of applying (120, 122, 124, 126) the porous or porosable base material (70, 70a, 71, 72, 73, 74) comprises a dotwise, linewise or layerwise application of the porous or porosable base material in a point-target matrix or in a layer-target matrix.

41. The additive manufacturing method according to claim 40, wherein the applying (120, 122, 124, 126) comprises:
approaching (120) a point to be approached of the point-target matrix at which the porous or porosable base material (70, 70a, 71, 72, 73, 74) is to be applied;
adjusting (110, 112, 114, 116, 118, 119) the porous or porosable base material at the point to be approached of the point-target matrix; and
applying the adjusted porous or porosable base material at the point.

42. The additive manufacturing method according to claim 39, further comprising:
applying at least one first point of a point-target matrix and adjusting (110, 112, 114, 116, 118, 119) the porous or porosable base material at the at least one first point such that a porous material structure (60) is formed at the at least one first point; and
applying (120) at least one second point of the point-target matrix and adjusting (110, 112, 114, 116, 118, 119) the porous or porosable base material (70, 70a, 71, 72, 73, 74) at the at least one second point such that an impermeable material structure (64) is formed at the at least one second point.

43. The additive manufacturing method according to claim 40, wherein points of the point-target matrix are arranged in deposition layers and wherein the applying (120) of the points of the point-target matrix is carried out in layers such that first points of a first deposition layer are applied and subsequently points of a second deposition layer are applied.

44. The additive manufacturing method according to claim 43, wherein the step of applying (120) comprises depositing the porous or porosable base material (70, 70a, 71, 72, 73, 74) such that:
at least one deposit layer has regions of impermeable material structure (64); and/or
at least one deposition layer comprises regions with porous material structure (60); and/or
at least one deposition layer comprises both impermeable material structure (64) and porous material structure (60), which is applied with the same porous or porosable base material.

45. The additive manufacturing method according to claim 39, wherein the applying (120) of the porous or porosable base material (70, 70a, 71, 72, 73, 74) is carried out such that:
the partially or locally porous material structure (60) of the component (50) is chaotically arranged or built up; and/or
the partially or locally porous material structure (60) of the component (50) is formed in or on the component with the applying (120) of the base material and has a non-repetitive structure or arrangement.

46. The additive manufacturing method according to claim 39, comprising at least one of:
the base material (70, 70a, 71, 72, 73, 74) is adjusted to be intrinsically porous;
the porous material structure (60) has an open porosity;
an impermeable material structure (64) has a closed porosity;
the porous material structure (60) is characterized in that it is set to be at least partially permeable for a fluid or components of the fluid; and
the porous material structure (60) is characterized in that there is a lower resistance for a flow or penetration of the fluid through the porous material structure than in the impermeable material structure (64).

47. The additive manufacturing method according to claim 39, wherein the porous material structure (60) has an open microporous or mesoporous structure with an average pore size smaller than 40 μm.

48. The additive manufacturing method according to claim 39, wherein the porous material structure (60) has an average volume porosity of 20% or greater.

49. The additive manufacturing method according to claim 39, wherein an impermeable material structure (64) has a higher density than the porous material structure (60) and wherein a ratio of a density in the impermeable material structure to the porous material structure is 1.2:1.

50. The additive manufacturing method according to claim 39, wherein the step of adjusting (110) comprises at least one:
admixing (112) additive (75) or filler (76) to the base material for adjusting the porosity at a moment of material application;
adjusting curing parameters (114) for a respective point (50a) of a point-target matrix to be applied;
selecting (116) a base material to be applied from a plurality of at least two base materials, wherein the at least two base materials can be supplied alternately or simultaneously;
providing (118) a location-dependent radiation intensity (83c) by a radiation source (83a) which is directed onto the material application; and
location-dependent adjustment (119) of a light absorption capability of the porous or porosable base material such that the component construction can be carried out by a location-independent radiation source (83a).

51. The additive manufacturing method according to claim 50, wherein at least one of polymeric or inorganic nanoparticles are used as additive (75) or an inorganic or organic filler is used as filler (76).

52. The additive manufacturing method according to claim 39, wherein pores (31, 31A, 31B) of the porous or porosable base material (70, 71, 72, 73, 74) are shaped or prepared during the applying such that:
the pores form a coherent porous material structure (60) in the component (50); and/or
the pores have a rounded or potato-shaped individual structure.

53. The additive manufacturing method according to claim 39, wherein the porous material structure (60) permeably separates a shell side of the porous structure from a carrier side of the porous structure.

54. The additive manufacturing method according to claim 39, wherein the porous or porosable base material comprises a solvent and wherein polymeric constituents of the base material are bound or dissolved in the solvent.

55. A monolithic component (50), comprising:
a first end face (2) and a second end face (2a) opposite the first end face (2); and
a porous structure (60) arranged between the first and second end faces and integrally constructed and connected to the first and second end faces, wherein the porous structure is at least partially or locally permeable;
wherein the porous structure permeably separates a shell side of the porous structure from a carrier side of the porous structure at least partially and/or at least locally;
wherein a carrier fluid is providable on the carrier side;
wherein the porous structure is configured to ensure a material transfer of the carrier fluid with the shell side.

56. The monolithic component (50) according to claim 55, wherein the monolithic component (50) is configured as a membrane element (62) for a filter device or is configured as a filter device and is monolithically constructed with the porous structure (60) as the membrane element.

57. The monolithic component (50) according to claim 55, further comprising an enclosure (5) formed monolithically with the porous structure (60) and the first and second end faces, wherein the porous structure is enclosed by the enclosure together with the first and second end faces.

58. The monolithic component (50) according to claim 55, wherein:
a shell fluid is providable on the shell side (10) such that both the carrier fluid and the shell fluid are flowable in or through the monolithic component and the carrier fluid is separated from the shell fluid by the porous structure (60); and/or
the porous structure (60) is semi-permeable or selectively permeable; and/or
the porous structure (60) is permeable for substances and/or particles having a size smaller than 10 μm.

59. The monolithic component (50) according to claim 55, wherein the monolithic component (50) is configured to receive and discharge the carrier fluid on the carrier side (1) and a shell fluid on the shell side (10) such that the carrier fluid and the shell fluid are flowable through the monolithic component to provide a carrier flow and a shell flow in the monolithic component.

60. The monolithic component (50) according to claim 55, wherein the porous structure (60) comprises filter capillaries (1).

61. The monolithic component (50) according to claim 55, wherein:
the first end face (2) is plate-shaped and the porous structure (60) is integrally formed on the first end face; and/or
the second end face (2a) is plate-shaped and the porous structure (60) is integrally formed on the second end face.

62. The monolithic component (50) according to claim 55, wherein the porous structure (60) comprises a plurality of elongated membrane tubes or filter capillaries (1) integrally connecting the first end face (2) to the second end face (2a).

63. The monolithic component (50) according to claim 62, wherein:
the membrane tubes or filter capillaries (1) have an inner side, wherein the inner side forms the carrier side; and/or
the membrane tubes or filter capillaries have an outer side, wherein the outer side forms the shell side (10).

64. The monolithic component (50) according to claim 62, further comprising:
the membrane tubes or filter capillaries (1) comprise a tubular configuration; and/or
the membrane tubes or filter capillaries (1) are extended in an essentially straight tubular manner; and/or
the membrane tubes or filter capillaries (1) have an intertwined configuration and are extended in a meandering or helical manner.

65. The monolithic component (50) according to claim 62, wherein the membrane tubes or filter capillaries (1) each have a first and a second orifice (3), respectively, through which a fluid is flowable and which are respectively integral with the first and the second end faces (2, 2a).

66. The monolithic component (50) according to claim 65, wherein the respective orifice (3) has a flow-conducting surface design (4, 4a) which is constructed concentrically around the orifice and merges integrally into the respective first and second end face (2, 2a).

67. The monolithic component (50) according to claim 55, further comprising:
a first carrier fluid collection port (7) monolithically formed with the first end face (2) and the porous structure (60); and/or
second carrier fluid collection port (7a) monolithically formed with the second end face (2a) and the porous structure (60); and/or
a shell fluid port (8, 8a) monolithically formed with the porous structure (60).

68. The monolithic component (50) according to claim 55, wherein the porous structure (60) further comprises at least one connection, cross-connection, or stiffener (17, 17a) monolithically formed with the porous structure to increase a mechanical stability of the porous structure.

69. The monolithic component (50) according to claim 68, wherein the at least one connection, cross-connection, or stiffener (17, 17a) directly integrally connects the porous structure (60) to an enclosure (5) formed monolithically with the porous structure (60) and the first and second end faces, wherein the porous structure is enclosed by the enclosure together with the first and second end faces.

70. The monolithic component (50) according to claim 55, wherein the porous structure (60) comprises at least one of at least one turbulator (29, 29a) for mixing the carrier fluid and/or for mixing a shell fluid, or a length-variable flow cross-section for the carrier fluid and/or the shell fluid.

71. The monolithic component (50) according to claim 55, wherein the porous structure (60) has:
a higher or lower porosity and/or pore width distribution in areas or in part; and/or
impermeable areas (64), permeable areas and areas having a different porosity compared to both the impermeable areas and the permeable areas.

72. The monolithic component (50) according to claim 55, wherein the first and/or the second end face (2, 2a) comprises an integral fluid barrier or is configured as an integral fluid barrier and wherein the fluid barrier separates a flow of the carrier fluid from a shell flow.

73. The monolithic component (50) according to claim 55, wherein the monolithic component is constructed from the porous or porosable base material.

74. The monolithic component (50) according to claim 73, wherein the porous or porosable base material comprises at least:
inorganic constituents; and/or
polymers.

75. The monolithic component (50) according to claim 55, wherein the monolithic component (50) is manufactured by the method of claim 39.

76. A monolithically constructed filter module (50) for a device for separating constituents from a fluid, comprising:
a first end face and a second end face (2, 2a) opposite the first end face (2);
a filter housing (5, 62) formed integrally with the first and the second end faces;
a porous structure (60, 64) arranged in the filter housing and integrally constructed and connected to the first and second end faces and the filter housing, wherein the porous structure permeable at least in part or locally;
a carrier fluid collecting connection (7, 7a); and
a shell fluid connection (8, 8a);
wherein the first end face and the second end face are each an integral fluid barrier for preventing a crossflow between the carrier fluid collecting connection and the shell fluid connection;
wherein the porous structure permeably separates shell side (10) of the porous structure from a carrier side (1) of the porous structure at least partially and/or at least locally;
wherein a carrier fluid is providable on the carrier side;
wherein the porous structure is configured to ensure a material transfer of the carrier fluid with the shell side.
